(19) United States
(12) Patent Application Publication
(10) Pub. No.: US 2021/0061712 A1
(43) Pub. Date: Mar. 4, 2021

(54) COMPOSITE STRUCTURAL MATERIAL COMPOSITIONS RESISTANT TO BIODEGRADATION

(71) Applicant: The University of British Columbia, Vancouver (CA)

(72) Inventors: Negar ROGHANIAN, North Vancouver (CA); Nemkumar BANTHIA, Vancouver (CA)

(21) Appl. No.: 17/017,527

(22) Filed: Sep. 10, 2020

Related U.S. Application Data
(63) Continuation of application No. PCT/CA2019/050294, filed on Mar. 8, 2019.
(60) Provisional application No. 62/642,883, filed on Mar. 14, 2018.

(51) Int. Cl. C04B 28/00; C04B 28/30; C04B 20/00; A01N 25/08; C09D 1/06; C09D 5/08; C09D 5/14

(52) U.S. Cl. CPC C04B 28/006; C04B 28/30; C04B 20/0048; A01N 25/08; C04B 2111/2092; C09D 5/08; C09D 5/14; C04B 20/0016; C09D 1/06

(57) ABSTRACT

A structural material composition comprises: a geopolymer matrix, the geopolymer matrix formed from an alumina silicate source and an alkaline activator; and an antibacterial agent (e.g. biocide and/or heavy-metal based antibacterial agent) encapsulated in an antibacterial agent carrier to form a first plurality of encapsulated antibacterial agent particles. The first plurality of encapsulated antibacterial agent particles is integrated with the geopolymer matrix during polymerization.

### REFERENCE TO RELATED APPLICATIONS

This application is a continuation of Patent Cooperation Treaty (PCT) application No. PCT/CA2019/050294 filed 8 Mar. 2019, which in turn claims priority from, and the benefit under 35 USC 119(e) of, U.S. application No. 62/642883 filed 14 Mar. 2018. All of the Applications referred to in this paragraph are hereby incorporated herein by reference.

### TECHNICAL FIELD

This application relates to geopolymerizing structural material compositions that are resistant to degradation due to bio-corrosion. Such structural material compositions can be used to fabricate structures. Such structural material compositions can be mixed with concrete and/or other construction materials (e.g. mixed with curable construction materials prior to curing) and the mixture can then be used to fabricate structures. Such structural material compositions can be used and/or to coat existing structures fabricated from concrete and/or other construction materials.

### BACKGROUND

Concrete is the most widely used construction material in large water and wastewater treatment plants, pipelines and conduits because of its low cost and ability to take forms. In North America, more than 75 percent of the population is served by wastewater collection systems and treatment plants for which concrete is a key construction material because of its longevity, ease of installation and local availability (U.S. Environmental Protection Agency. (2004). An examination of EPA risk assessment principles and practices. Washington DC: Office of the Science Advisor. PA 100/B-04/001). Although concrete has been long-established construction material, as with any structural component, it has its limitations.

Thousands of kilometers sewage pipelines suffer from severe bio-corrosion caused by prolonged exposure to highly aggressive environments. Bio-corrosion in sewage pipes is mainly caused by the diffusion of aggressive solutions and in situ production of sulfuric acid by sulphur-oxidizing microorganisms which affect the physicochemical properties of concrete pipes. In this study an accelerated pilot-scale experimental setup is designed and built to replicate conditions in sewage transport systems as well as the bacterial induced corrosion processes in pipes. The reliability of the accelerated set-up is evaluated by conducting different tests on corroded samples over a 6 months period. In addition to the parameters such as weight loss and pH measurements that have been investigated by previous authors, variations in corrosion depth, flexural strength and absorption were also studied.

Prevention of concrete bio-corrosion usually requires modification of concrete mix or application of antimicrobial coatings on the inner surface of the pipe. The composition of the coating is a key factor in controlling resistance to bio-corrosion which is dependent on the neutralization capacity of the material or its ability to prevent the growth of bacteria. The most common method for controlling the growth of bacteria is using bioactive chemicals (biocides) which are essentially toxic compounds. Undesired leaching of biocides to the surrounding environment as well as their short bio-resistance lifetime have increased the need for more efficient, environmental friendly and long-lasting alternatives.

In addition to wastewater systems, marine structures can also have problems related to microbiologically induced concrete deterioration. Marine environments have high concentrations of chloride ions and other salts in which microorganisms thrive. Oil and water storage systems are also affected by bacterial corrosion as the stagnant water around these structures can produce large amounts of hydrogen sulfide.

When the pipes deteriorate, the replacement by means of traditional open-cut methods is very costly and complicated. Over the past several decades many approaches were attempted to protect structures exposed to aggressive environments from bio-corrosion. However, few methods have shown acceptable long term performance. Mitigation methods consist of using bioactive chemicals (biocides) that disrupt bacteria growth on the surface of the concrete which often lose effectiveness over time due to leaching and chemical degradation. So often they require reapplication to remain effective. Other methods include using prevention techniques that apply physical changes on the surface of the pipe or use corrosion-resistant materials that make growth less likely to occur. Some of the most common techniques that are being used in wastewater concrete pipes include: physical cleaning of pipe surface, modification of concrete mix, application of chemical or antimicrobial thin layer of coating on the inner surface of concrete pipe or provide protective layer between concrete surface and corrosive solution, introduction of bactericides to the wastewater, chlorination, injection of compressed air and addition of lime which were attempted with limited success.

According to the literature, modification of concrete mixes by adding supplementary cementitious materials such as silica fume, fly ash and slag or using advanced cementitious materials with different chemical compositions and low calcium contents are reported to enhance the resistance of the pipes to some acceptable limits in acidic environments.

Another category of prevention methods are via the introduction of coating materials.

Concrete infrastructure repair may require using coating materials that fit naturally within existing structure but also within the environment in larger context. Current coating technologies are divided into four main groups. One of the most common repair options includes coating the pipe with cured-in-place cement-based or polymer based coating materials and liners such as epoxy, polyesters, high alumina cement, asphalt and PVC sheets (Montes, C., & Allouche, E. N. (2012). Evaluation of the potential of geopolymer mortar in the rehabilitation of buried infrastructure. Structure and Infrastructure Engineering, 8(1), 89-98.). However, there are common issues associated with this type of coatings such as cost, tendency to the propagation of cracks, pinholes or rips, delamination, corrosion, compatibility with the host material, short bio-resistance lifetime, poor adhesion to the substrate material and toxicity. Furthermore, coatings are prone to acid and/or bacteria penetrate the layer, corrode the host pipe substrate material behind the liner and destroy the bond. Also, in some cases it is difficult to monitor pipe's condition over time with conventional methods when it is coated with a thick layer of polymer-based coating. Success with protective coating materials has been variable.

The second type of repair technologies is introducing a coating which minimizes the adhesion of bacteria on the surface without involving chemical reactions. Generally, bacterial biofilm formation starts with initial attachment and adhesion of bacteria to surfaces. Microbial cells aggregate on the surface and produce insoluble polymeric substance called exopolysacharides (EPS) proteins that encase the adherent bacteria in a three dimensional matrix. EPS help the cell to adhere to a surface, trap nutrients and protect them from antibacterial. With accumulation of EPS and reproduction of bacteria, colonies develop into mature biofilm and exhibit increased resistance to removal. The chance of initial microbial attachment to the surface is dependent on coating material chemistry, surface topography, mechanical properties, surface hydrophobicity/surface energy, environmental conditions as well as bacterial surface structure (Graham, M. V., & Cady, N. C. (2014). Nano and microscale topographies for the prevention of bacterial surface fouling. Coatings, 4(1), 37-59). Anti-adhesive layers basically reduce the chance of microbial attachment to concrete surface, such as polydimethylsiloxane (PDMS) and polyethyleneglycol (PEG). These type of coatings are divided into two main categories, fouling release coatings including silicone- and fluoropolymer-based binders and engineered micro-topographical surfaces.

The third group are coatings integrated with antimicrobial agents or bioactive chemicals (biocides) that act on bacteria and limit or prevent their settlement. Biocides are considered to be the most commonly used materials to prevent the growth of undesirable microorganisms on concrete surfaces. Biocides were introduced in 1967 by the Penarth Research Center to inhibit microorganism growth on stonework with applications extended to ancient masonry buildings and cement-based substrates (Richardson, B. A. (1988). Control of microbial growths on stone and concrete. Biodeterioration 7, 101-106.). Currently more than 18 chemicals are used as biofilm inhibitor agents throughout the world. However, several challenges exist with respect to adding biocides to construction materials, such as the degradation of biocides into inactive compounds due to environmental conditions, fast dissipation due to leaching and/or volatilization from the surface film, short bio-resistance lifetime, high required concentrations and large dosage requirements in order to have a sustained long term effect. Moreover, since most of the effective biocides are essentially toxic chemical compounds, such as mercury-based biocides and tin-based biocides, the environmental impact of their release to the soil and water and the surrounding environment at such increased levels has led to stricter environmental legislations over the last decade and requires careful monitoring (Edge, M., Allen, N. S., Turner, D., Robinson, J., & Seal, K. (2001). The enhanced performance of biocidal additives in paints and coatings Progress in Organic Coatings, 43(1-3), 10-17.; Whitekettle, W. K., Tafel, G. J., & Zhao, Q. (2010). U.S. Pat. No. 7,824,557. Washington, DC: U.S. Patent and Trademark Office).

In addition to biocides, various antibacterial micro/nano agents and heavy metals also have toxic effect on sulfate-reducing microorganisms. Heavy metals ions such as zinc or silver impregnate the microbe surface and are absorbed by the cells through active transfer. The heavy metal ions react with metabolic enzymes within the metabolic system of the microbes. Ultimately, the activity of these enzymes is hindered and the growth of microbes is inhibited.

Coating the pipe's internal wall by cuprous oxide or silver oxide in epoxy is reported to reduce the bacterial corrosion (Hewayde, Esam H., et al. (2005) “The impact of coatings on biological generation of sulfides in wastewater concrete pipes,” Department of Chemical and Biochemical Engineering, The University of Western Ontario, London, Ont, Canada). Maeda et al. suggested the possibility of using nickel to prevent concrete corrosion (Maeda, T., Negishi, A., Nogami, Y., & Sugio, T. (1996). Nickel inhibition of the growth of a sulfur-oxidizing bacterium isolated from corroded concrete. Bioscience, biotechnology, and biochemistry, 60(4), 626-629). It is also been reported that sodium tungstate completely inhibits the growth of A. Thiooxidans cells (Negishi, A., Muraoka, T., Maeda, T., Takeuchi, F., Kanao, T., Kamimura, K., & Sugio, T. (2005). Growth inhibition by tungsten in the sulfur-oxidizing bacterium Acidithiobacillus thiooxidans. Bioscience, biotechnology, and biochemistry, 69(11), 2073-2080). However the use of metal salts in repair coatings is limited because of leachability into the surrounding environment, safety concerns and regulations that restrict levels of certain metals in sewer systems. Due to these challenges involved in using biocides, increasing attention is being paid to implementation of slow release mechanisms inside a material coating by integrating the biocide into a carrier or a mechanism which is able to release the antibacterial agent or biocide slowly to the environment. Slow release systems have the potential to extend the duration and efficiency of biocidal activity, modulate its release and reduce environmental pollution risks. In addition to the fact that antibacterial agents are protected from leaching out into the ecosystem, handling threats associated with skin sensitization could be minimized (Edge, M., Allen, N. S., Turner, D., Robinson, J., & Seal, K. (2001). The enhanced performance of biocidal additives in paints and coatings Progress in Organic Coatings, 43(1-3), 10-17.; Erich, S. J. F., Mendoza, S. M., Floor, W., Hermanns, S. P. M., Homan, W. J., & Adan, O. C. G. (2011). Decreased bio-inhibition of building materials due to transport of biocides. Heron, 56(3), 93.).

Microencapsulation of chemical compounds is a well-known method in chemical literature and drug delivery systems to gain control over the release of active components. In this method, the molecule is retained inside a protective framework until a trigger affects its release (Edge, M., Allen, N. S., Turner, D., Robinson, J., & Seal, K. (2001). The enhanced performance of biocidal additives in paints and coatings Progress in Organic Coatings, 43(1-3), 10-17.). Researchers demonstrated extended duration in biocidal activity with microencapsulated biocides (Gajanan, S. K., Swaminathan, S., & Ahmad, A. (2007). Composition of polymer microcapsules of biocide for coating material (US Patent 20070053950 ed.); Nydén, B. M., Nordsstierna, L. O., Bernad, E. M., & Abdalla, A. M. A. A. (2010). U.S. patent application Ser. No. 12/800,292.; [35] Jämsä, S., Mahlberg, R., Holopainen, U., Ropponen, J., Savolainen, A., & Ritschkoff, A. C. (2012). Slow release of a biocidal agent from polymeric microcapsules for preventing biodeterioration. Progress in Organic Coatings, 76(2013), 269-276). They also reported that the encapsulation is able to protect UV-sensitive biocides such as IPBC (iodopropynyl butyl carbamate) against premature degradation. In addition to extending the biocide effect, microencapsulation is able to reduce toxicity and cover odor of chemical compounds.

There are many studies looking at the synthesis of polymer-composite carriers impregnated with antimicrobial agents. These controlled release systems have attracted interest due to their potential of controlled-delivery of various active agents (Scarfato, P., Russo, P., & Acierno, D. (2011). Preparation, characterization, and release behavior of nanocomposite microparticles based on polystyrene and different layered silicates. Journal of Applied Polymer Science, 122(6), 3694-3700). However, the overall performance of a coating containing polymer-composite carriers are highly dependent on its compatibility with other materials. Aldcroft et al. in 2005 tested different porous inorganic carrier particles such as amorphous silicate, amorphous alumina and zeolites having biocides adsorbed within the pore system in surface coatings (Aldcroft, D., Jones, H., Turner, D., Edge, M., Robinson, J., & Seal, K. (2005). In U.S. Patent No. 6 9.,698 (Ed.), Particulate carrier for biocide formulations.). Botterhuis et al. and Sorensen et al. (2006) studied the effect of porous silica nano/micro particles loaded with biocide for controlled release applications. The studies show that a controlled leaching of biocide is obtained which protected the biocide from chemical degradation and extended the biocidal effect under accelerated weathering tests (Botterhuis, N. E., Sun, Q., Magusin, P. C., van Santen, R. A., & Sommerdijk, N. A. (2006). Hollow silica spheres with an ordered pore structure and their application in controlled release studies. Chemistry-a European Journal, 12(5), 1448-1456; Sørensen, G., Nielsen, A. L., Pedersen, M. M., Poulsen, S., Nissen, H., Poulsen, M., & Nygaard, S. D. (2010). Controlled release of biocide from silica microparticles in wood paint. Progress in Organic Coatings, 68(4), 299-306.).

In recent years, nanometer-scale hollow cylinders or nano-tubes have emerged as a good biocide-loading carrier option due to their large inner volumes. Lvov et al. (2008) studied two layer alumino-silicate Halloysite clay nanotubes as an entrapment system for storage, loading and control release of anticorrosion agents. In the search for slow released systems, clay minerals are also widely used materials for modulating drug delivery (Lvov, Y. M., Shchukin, D. G., Mohwald, H., & Price, R. R. (2008). Halloysite clay nanotubes for controlled release of protective agents. ACS Nano, 2(5), 814-820). This is due to their high storing capacities as well as swelling and colloidal properties (Aguzzi, C., Cerezo, P., Viseras, C., & Caramella, C. (2007). Use of clays as drug delivery systems: possibilities and limitations. Applied Clay Science, 36(1), 22-36.).

Another method to gain control over the release of active components is to retain and solidify the antibacterial ions or heavy metal molecule in 3D framework of the coating material matrix. Antibacterial agents could be a combined as part of the material matrix or simply be embedded in the pores of the structure. Two examples are geopolymer and magnesium phosphate cement with the ability to immobilize and tightly lock heavy metals such Zn²⁺, Cu²⁺, Cr³⁺, Cd²⁺, Pb²⁺, TiO₂ and MnO into their 3D network with minimum losses in compressive strength and mechanical properties (Terzano, R., Spagnuolo, M., Medici, L., Vekemans, B., Vincze, L., Janssens, K., & Ruggiero, P. (2005). Copper stabilization by zeolite synthesis in polluted soils treated with coal fly ash. Environmental science & technology, 39(16), 6280-6287.; Wang, S., Li, L., & Zhu, Z. H. (2007). Solid-state conversion of fly ash to effective adsorbents for Cu removal from wastewater. Journal of hazardous materials, 139(2), 254-259.; Xu, J. Z., Zhou, Y. L., Chang, Q., & Qu, H. Q. (2006). Study on the factors of affecting the immobilization of heavy metals in fly ash-based geopolymers. Materials letters, 60(6), 820-822.; Van Jaarsveld, J. G. S., Van Deventer, J. S. J., & Lorenzen, L. (1997). The potential use of geopolymeric materials to immobilise toxic metals: Part I. Theory and applications. Minerals Engineering, 10(7), 659-669.). The microstructure of these materials is similar to zeolites or feldspathoids which are known for their excellence ability in absorbing and solidifying chemicals/heavy metal and thus they have been used as a potential matrix for waste stabilization during the last decade. Waltraud M. Kriven et al. reported that Geopolymer-based material containing silver/copper particles is a possible coating with a combination of antibacterial activity and good adhesion to majority of inorganic surfaces (Kriven, W. M. (2010). Inorganic polysialates or'geopolymers'. American Ceramic Society Bulletin, 89(4), 31-34.). However, geopolymer has limited potential to solidify and encapsulate the antibacterial agent. In addition, depending on the antibacterial agent used, the encapsulation process of heavy metals in the geopolymer matrix may affect geopolymerization reaction and mechanical properties.

There is a general desire to overcome the current rehabilitation challenges by developing a sustainable repair coating to prevent concrete bio-corrosion, yield a prolonged exposure of the biocide and extend the durability and service life of the concrete pipes.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Aspects of the invention relate to geopolymerizing structural material compositions that are resistant to degradation due to bio-corrosion. Such structural material compositions can be used to fabricate structures. Such structural material compositions can be mixed with concrete and/or other construction materials (e.g. mixed with curable construction materials prior to curing) and the mixture can then be used to fabricate structures. Such structural material compositions can be used to fabricate structures and/or to coat existing structures fabricated from concrete and/or other construction materials.

One aspect of the invention provides a structural material composition comprising an antibacterial agent encapsulated in an antibacterial agent carrier to form a plurality of encapsulated antibacterial agent particles wherein the plurality of encapsulated antibacterial agent particles is integrated with the geopolymer matrix during polymerization.

In some embodiments, the antibacterial agent comprises a heavy metal element such as, for example, titanium, nickel, copper, silver, tungstate or zinc. In some embodiments, the antibacterial agent comprises a compound (e.g. an oxide) comprising a heavy metal element such as, for example, titanium oxide (TiO₂), zinc oxide (ZnO) and sodium tungstate (Na₂WO₄). In some embodiments, the antibacterial agent comprises a biocide (e.g. a bioactive chemical or toxic chemical employed for controlling the growth of bacteria).

In some embodiments, the antibacterial agent carrier may comprise bentonite clay (Al₂H₂Na₂O₁₃Si₄), halloysite clay, metakaoline and/or zeolite. To allow for more antibacterial agent to be encapsulated in the antibacterial agent carrier, the antibacterial agent carrier may be purified to remove unwanted elements and make more space to encapsulate the antibacterial agent. Such purification may comprise absorbing impurities in a chemical solution and subsequently drying the antibacterial agent carrier.

The antibacterial agent may be encapsulated in the antibacterial agent carrier. In some embodiments, the antibacterial agent may be microencapsulated in the antibacterial agent carrier. In some embodiments, the antibacterial agent may be encapsulated in the antibacterial agent carrier through an ion exchange process whereby one or more ions of the antibacterial agent carrier are replaced with one or more atoms of the antibacterial agent.

In some embodiments, the geopolymer may, for example, be formed by a reaction that produces SiO₄ and AlO₄ tetrahedral frameworks linked by shared oxygens. The connection of the tetrahedral frameworks may occur via covalent bonds. A geopolymer structure may be perceived as a dense amorphous phase consisting of semi-crystalline three-dimensional aluminosilicate microstructure. The microstructure of geopolymers on a nanometer scale observed by TEM may comprise small aluminosilicate clusters with pores (or voids) dispersed within a highly porous network. The cluster sizes may be, for example, between 5 and 10 nanometers. This highly porous network or dense amorphous phase consisting of semi-crystalline 3 three-dimensional aluminosilicate microstructure may be referred to herein as a geopolymer matrix.

In some embodiments, the geopolymer matrix is formed from an alumina silicate source and an alkaline activator. The alumina silicate source may comprise fly ash (e.g. type F fly ash or another fly ash having less than 15 wt % CaO), slag and/or metakaoline. In some embodiments, the alumina silicate source exhibits a loss on ignition (“L.O.I.”) of less than 5 wt %. In some embodiments, the alumina silicate source has a composition having less than 10 wt % Fe₂O₃, between 40 wt % and 50 wt % silica and/or less than 15 wt % CaO. In some embodiments, the alumina silicate source has a composition having less than 10 wt % CaO. By minimizing the amount of calcium and/or CaO, the structural material composition may be less susceptible to bio-corrosion. The Alkaline activator may comprise a solution of at least one of sodium hydroxide (10-14 Molar) and potassium hydroxide (10-14 Molar) and at least one of sodium silicate and potassium silicate. The geopolymer matrix may be formed by adding the alkaline activator to the alumina silicate source. Water may also be added to slow down the reaction between the alumina silicate source and the alkaline activator (e.g. to reduce setting time) and/or to facilitate handling during geopolymerization.

The encapsulated antibacterial agent particles may be integrated with the geopolymer matrix. In some embodiments, the encapsulated antibacterial agent particles may be integrated with the geopolymer matrix before the geopolymer matrix is formed (e.g. before geopolymerization of the alumina silicate source and the alkaline activator).

In some embodiments, integration comprises physical integration of the encapsulated antibacterial agent particles with the geopolymer matrix. For example, the encapsulated antibacterial agent particles may be located in voids of the geopolymer matrix. Where the encapsulated antibacterial agent particles are located in voids of the geopolymer matrix, the encapsulated antibacterial agent particles may increase the density and decrease the porosity of the geopolymer matrix thereby improving structural characteristics such as, for example, increasing tensile strength, increasing compressive strength, increasing toughness, increasing hardness and/or decreasing porosity of the geopolymer matrix and reducing the likelihood of ingress of bacteria into the geopolymer matrix.

In some embodiments, integration comprises chemical integration. For example, the encapsulated antibacterial agent particles may form chemical bonds with the geopolymer matrix.

In some embodiments, the antibacterial agent carrier comprises aluminum and or silicon (such as would be the case for a bentonite antibacterial agent carrier) and integration of the encapsulated antibacterial agent particles with the geopolymer matrix to form the structural material composition comprises co-geopolymerizing the encapsulated antibacterial agent particles with the geopolymer matrix. Since the antibacterial agent carrier comprises aluminum and or silicon, the antibacterial agent carrier becomes part of the geopolymerization reaction, thereby improving the bond between encapsulated antibacterial agent particles and the geopolymer matrix.

In some embodiments, integration comprises a combination of two or more of physical integration, chemical integration and co-geopolymerization.

Since the first plurality of encapsulated antibacterial agent particles is integrated with the geopolymer matrix during polymerization, the antibacterial agent is less likely to leach from the structural material composition. Since the antibacterial agent is less likely to leach from the structural material composition, antibacterial characteristics of the structural material composition may last longer (e.g. due to the constant presence of the antibacterial agent in the structural material composition) and the structural material composition may have a reduced impact on the environment since fewer antibacterial agent particles, which may be harmful to the environment, are leached into the environment over a given period of time.

In some embodiments, additional curable material may be added to the encapsulated antibacterial agent particles integrated with the geopolymer matrix. It may be desirable for the additional curable material to itself not be vulnerable to acid. It may be desirable for the additional curable material to itself have desired structural characteristics such as, for example, high tensile strength, high compressive strength, high toughness, high hardness and/or low porosity. It may be desirable for the additional curable material to have a similar microstructure to the geopolymer.

In some embodiments, magnesium phosphate cement (referred to herein as magnesium cement) may be added to the encapsulated antibacterial agent particles integrated with the geopolymer matrix prior to geopolymerization. Magnesium cement may be formed by mixing at least one of magnesium oxide and magnesium silicate with at least one of mono-potassium phosphate, ammonium dihydrogen phosphate, and sodium dihydrogen phosphate. Water may be added while mixing the magnesium cement. Sodium borate, sodium tetraborate and/or disodium tetraborate (commonly sold under the name Borax™) may be added while mixing the magnesium cement to retard the reaction (e.g. setting) of the magnesium cement.

The magnesium cement may improve the structural characteristics such as, for example, increasing tensile strength, increasing compressive strength, increasing toughness, increasing hardness and/or decreasing porosity of the structural material composition by filling the voids of the geopolymer matrix, by increasing the density of the structural material composition and by providing its own structural characteristics to the structural material composition.

The magnesium cement may provide secondary voids in which encapsulated antibacterial agent particles may be located thereby allowing for the structural material composition to contain more encapsulated antibacterial agent particles. The magnesium cement may provide bonding sites for encapsulated antibacterial agent particles to chemically bond to the magnesium cement thereby allowing for the structural material composition to contain more encapsulated antibacterial agent particles. Once geopolymerized/cured, the magnesium cement may absorb water in contact with the structural material composition, causing the magnesium cement to expand to further increase the density and reduce the porosity of the structural material composition.

In some embodiments, to further improve the tensile strength of the structural material composition, reinforcing fibers may be added before or during geopolymerization of the geopolymer matrix. For example, in some embodiments polymer fibers such as poly-vinyl alcohol fibers, glass fibers and/or carbon fibers, may be added to structural material composition. In some embodiments, it may be desirable for the reinforcing fibers to not be vulnerable to acid or bio-corrosion.

In some embodiments, the structural material composition may be employed as a coating on at least a portion of a surface of a structure made of curable material (e.g. concrete), polymer or metal to reduce bio-corrosion of the structure. Such structures may include wastewater pipes, oil and gas pipes, bridge supports and other structures vulnerable to bio-corrosion. Such structures may include any type of infrastructure or structure exposed to deterioration, aggressive environment, bacteria conducive environments (e.g. high humidity, long cycles of humidification and drying, high carbon dioxide concentrations, high concentrations of chloride ions or other salts or high concentrations of sulfates and acidic environments), molds, fungus and microbiological corrosion and any type of deterioration arising from biological sources, such as wastewater pipes, oil and gas pipes, residual water treatment plants, marine infrastructure and storing tanks.

A coating comprising the structural material composition described herein may be applied to a structure by brushing it onto the structure or by spraying it onto the structure (e.g. pneumatically projecting the structural material composition onto the structure).

In some embodiments, a structure may be fabricated in whole or in part from the structural material composition. The structural material composition (or a mixture including the structural material composition) may be poured into a formwork and allowed to cure/geopolymerize. In some embodiments, the structural material composition is mixed with concrete or a similar curable construction material. Such structures may include wastewater pipes, oil and gas pipes, bridge supports and other structures vulnerable to bio-corrosion. Such structures may include any type of infrastructure or structure exposed to deterioration, aggressive environment, bacteria conducive environments (e.g. high humidity, long cycles of humidification and drying, high carbon dioxide concentrations, high concentrations of chloride ions or other salts or high concentrations of sulfates and acidic environments), molds, fungus and microbiological corrosion and any type of deterioration arising from biological sources, such as wastewater pipes, oil and gas pipes, residual water treatment plants, marine infrastructure and storing tanks.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is an illustrative diagram showing the stages of biofilm formation.

FIG. 2 shows experimental SEM-EDS results of matrix mineral content of pre-treated and non-pre-treated clay particles.

FIG. 3 shows SEM images of clay samples (at two different magnifications) before pre-treatment.

FIG. 4 shows SEM images of clay samples (at two different magnifications) after pre-treatment.

FIG. 5 shows an SEM image of ion-exchanged bentonite clay.

FIG. 6 is a comparison between the chemical composition of clay and zinc-doped clay.

FIG. 7 shows how samples were prepared for tensile strength tests performed in experiments conducted by the inventors.

FIG. 8 shows how samples were prepared for chemical stability tests performed in experiments conducted by the inventors.

FIG. 9 shows variation of compressive strength for samples in experiments conducted by the inventors.

FIG. 10 is a photo of the uniaxial tensile test set up for in experiments conducted by the inventors.

FIG. 11 shows plots of load/displacement curves for the G1 mix in experiments conducted by the inventors.

FIG. 12 shows plots of load/displacement curves for the G2 mix in experiments conducted by the inventors.

FIG. 13 shows plots of load/displacement curves for the G3 mix in experiments conducted by the inventors.

FIG. 14 shows plots of load/displacement curves for the G4 mix in experiments conducted by the inventors.

FIG. 15 shows plots of load/displacement curves for the G5 mix in experiments conducted by the inventors.

FIG. 16 shows plots of load/displacement curves for the G6 mix in experiments conducted by the inventors.

FIG. 17 shows plots of load/displacement curves for the G9 mix in experiments conducted by the inventors.

FIG. 18 shows SEM images of geopolymer samples in batch 5 of the experiments conducted by the inventors.

FIG. 19 shows SEM images of geopolymer samples in batch 4 of the experiments conducted by the inventors.

FIG. 20 shows the chemical composition of geopolymer samples in comparison to cement mortar samples.

FIG. 21 is a plot showing mass loss vs. immersion time in acid sulfuric (pH=1.5) for batch G2, batch G4, batch G5 and batch G9.

FIG. 22 is a photograph showing chemical stability of geopolymer samples observed in experiments conducted by the inventors after 6 weeks.

FIG. 23 is a photograph showing chemical stability of geopolymer samples observed in experiments conducted by the inventors after 8 weeks.

FIG. 24 is a plot showing uniaxial tensile test results for mix design M2, M3 and M4 described in Table 7.

FIG. 25 is a plot showing uniaxial tensile test results for mix design M5, M6 and M7 described in Table 7.

FIG. 26 is a plot showing uniaxial tensile test results for mix design M8, M9 and M10 described in Table 7.

FIG. 27 shows stress-strain curves for mix design M2, M5, M9 and M10 described in Table 7 after 7 and 14 days.

FIG. 28 shows toughness values (in J·m⁻³) for mix design M2, M6, M9 and M10 described in Table 7 after 7 and 14 days.

FIG. 29 shows the application of the M2, M5, M9 and M10 mixes to concrete blocks for the bond tests conducted by the inventors.

FIG. 30 shows the curing of the coated samples for the bond tests conducted by the inventors.

FIG. 31 shows the installation of metal fixtures into the coated samples of FIG. 30 and pull-off testing procedure used for the bond tests conducted by the inventors.

FIG. 32 shows a summary of the bond strength experiments conducted by the inventors.

FIG. 33 is a schematic illustration of the plastic shrinkage inducing chamber used in the experiments conducted by the inventors.

FIG. 34 is a pair of photographs showing the application of the coating materials on shrinkage samples according to experiments conducted by the inventors.

FIG. 35 is a pair of photographs of the plastic shrinkage crack inducing environmental chamber used in the experiments conducted by the inventors.

FIG. 36 is a photograph showing sample preparation for SEM-EDS surface morphology testing in experiments conducted by the inventors.

FIG. 37 is an SEM image of the M1 mix in the surface morphology experiments conducted by the inventors.

FIG. 38 is a number of SEM image of the M2 mix in the surface morphology experiments conducted by the inventors.

FIG. 39 is a number of SEM image of the M10 mix in the surface morphology experiments conducted by the inventors.

FIG. 40 is a number of SEM image of the M6 mix in the surface morphology experiments conducted by the inventors.

FIG. 41 is an SEM image of the M5 mix in the surface morphology experiments conducted by the inventors.

FIG. 42 is a chemical composition map of geopolymer mix M5 in experiments conducted by the inventors.

FIG. 43 is a chemical composition map of a blended geopolymer mix (mix M6) integrated with ZnO in experiments conducted by the inventors.

FIG. 44 is a plot comparing the chemical compositions of mixes, M1 (Geopolymer mix), M2 (blended mix of geopolymer and magnesium phosphate), M5 (M1 integrated with zinc oxide particles) and M6 (blended mix (geopolymer and magnesium cement) integrated with zinc oxide particles).

FIG. 45 is a plot showing leaching test performed on cement mortar, geopolymer and a blended mix (geopolymer with magnesium cement) in this experiment.

FIG. 46 is a plot showing the leaching rate of different experimental mixes after 120 days wherein: CZF is cement mortar sample mixed with ZnO; CCZF is cement paste combined with Zn-doped clay particles; GZF is a geopolymer sample mixed with ZnO; CGZF is a geopolymer sample combined with Zn-doped clay particles; HM is a blended (geopolymer and magnesium cement) sample mixed with ZnO; and HMCZ is a lended sample of geopolymer and magnesium cement mixed with Zn-doped clay particles.

FIG. 47 shows photographs of a number of samples subjected to the leaching test conducted by the inventors by acid environment immersion for 16 weeks.

FIG. 48 shows photos of the degration of CZF samples in the leaching test conducted by the inventors by acid environment immersion.

FIG. 49 shows plots of experimental antibacterial leaching rates of a number of samples on which the inventors conducted experiments.

FIG. 50 shows photographs of various samples which illustrate chemical stability after immersion in an acidic environment for 16 weeks.

FIG. 51 shows plots which illustrate load bearing capacity of a number of concrete samples (with various coating materials) after being in a bio-corrosion testing chamber over a six month period.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Aspects of the invention relate to geopolymerizing structural material compositions that are resistant to degradation due to bio-corrosion. Such structural material compositions can be used to fabricate structures. Such structural material compositions can be mixed with concrete and/or other construction materials (e.g. mixed with curable construction materials prior to curing) and the mixture can then be used to fabricate structures. Such structural material compositions can be used and/or to coat existing structures fabricated from concrete and/or other construction materials.

Geopolymers have been described as comprising a polymeric Si—O—Al framework, similar to zeolites. A difference between geopolymers and zeolite is that geopolymers are amorphous instead of crystalline. The microstructure of geopolymers on a nanometer scale observed by TEM typically comprises small aluminosilicate clusters with pores dispersed within a highly porous network. The clusters sizes typically range between 5 and 10 nanometers. The geopolymerization reaction may produce SiO₄ and AlO₄, tetrahedral frameworks linked by shared oxygens as poly(sialates) or poly(sialate-siloxo) or poly(sialate-disiloxo) depending on the SiO₂/Al₂O₃ ratio in the system. The connection of the tetrahedral frameworks may occur via long-range covalent bonds. Thus, geopolymer structure may be perceived as dense amorphous phase comprising semi-crystalline 3-D alumino-silicate microstructure.

Aspects of the invention provide a structural material composition comprising: a geopolymer matrix, the geopolymer matrix formed from an alumina silicate source and an alkaline activator; and a biocide encapsulated in a biocide carrier to form a first plurality of encapsulated biocide particles. The first plurality of encapsulated biocide particles is integrated with the geopolymer matrix during polymerization.

### 1 Concrete Pipe Coating Strategies

### 1.1 Protective Coatings

In the context of pipe (e.g. sewer pipe) rehabilitation, protective coatings are currently the most widely used means of preventing further corrosion. Most existing coating strategies rely on using a protective and corrosion-resistant material between the concrete surface and the corrosive solution. Examples of such corrosion-resistant material include: cement-based mortars, epoxy, mortar epoxy, polyesters, high alumina cement, asphalt and PVC membranes.

Initially, the pipe is typically prepared by being emptied and washed (e.g. with a water jet). Then, in the case of polymer-based coatings such as PVC membrane, the unformed PVC coating is entered into the pipe and brought through the entire length of the pipe. Once the coating has been put all the way through the pipe, the thermoplastic is heated to its designated temperature to make it workable. The PVC is then molded to the edge of the corroded pipe with a specialized molding device. After it is molded, the thermoplastic is set and will no longer be pliable, so long as its temperature remains below the pliability temperature.

Similar to the polymer-based coatings, mortar coatings typically involve washing and otherwise preparing the pipe prior to application of the mortar coatings. Then different methods (e.g. trowel) may be used to apply the coating inside pipes which helps to repair corrosion damages and seal leaks. Also, the mortar or epoxy mixture can be sprayed on, by hand which is comparatively less expensive and less laborious than the process of setting a PVC coating.

Common issues associated with prior art protective coatings include: cost, tendency for the propagation of cracks, pinholes or rips, delamination, corrosion, incompatibility with the substrate material, short bio-resistance lifetime, poor adhesion to the substrate material, long setting time, considerable thermal expansion and toxicity. Furthermore, most coatings are highly permeable and prone to having acid and/or bacteria penetrate the layer, corrode the concrete substrate beneath the coating and/or destroy the bond of the coating to the substrate. It is reported that conventional prior art coatings often require reapplication after a year or more. In some cases the coating material impairs the breathability of the concrete which may cause blistering and/or coating failure. So success with protective coating materials has been variable and it is uncertain if they could be used as long term solutions.

### 1.2 Bactericide Coatings

A second category of coating in use today is a coating which includes antimicrobial bioactive chemicals (biocides) and/or heavy metals which act as antibacterial agents. Currently more than 18 different bioactive chemicals are used and classified according to their chemical structure and mode of antimicrobial action. Biocides typically attack bacteria through damaging or inhibiting the synthesis of cell walls or affecting bacterial DNA or RNA, proteins or metabolic pathways. Biocides may be fixed on surfaces, such as when biocides are included in paints, used in coatings and/or may be included in the construction material to be protected.

Concerns relating to the use of biocides in coating materials include: the range of microorganisms to be controlled; effectiveness of the biocide; compatibility of the chemical with the host coating or underlying pipe material; the toxicity of the biocide and requirements for its safe disposal; biodegradability of the biocide; and cost of the biocide. Other challenges associated with the use of biocides in coatings include: capability of providing protection over desired time scales; degradation of the biocide into inactive compounds; fast dissipation due to leaching and/or volatilization; short bio-resistance lifetime; and high required concentrations to have long term effect. An undesirable characteristic of using some biocides (such as mercury-based biocides, tin-based biocides, formaldehyde, copper compounds and chlorine) is that some of the chemical compounds that make up biocides are toxic and undesirable leaching of such compounds into the water and soil may cause adverse environmental effects.

Heavy metals such as copper, nickel, silver and zinc are also known for their antibacterial properties and have been used as an alternative for disinfection of wastewater in treatment plants. Coating a pipe's internal wall by cuprous oxide or silver oxide in epoxy is reported to reduce the bacterial corrosion. Hewayde, Esam H., et al. (2005) “The impact of coatings on biological generation of sulfides in wastewater concrete pipes,” Department of Chemical and Biochemical Engineering, The University of Western Ontario, London, Ont, Canada, used two concrete pipes coated with the metal oxides, then filled the pipes with nutrient and concentrated bacterial solutions (Desulfovibrio desulfricans strain). Results showed that the rate of corrosion for coated samples were less than uncoated samples, but silver oxide showed poor adhesion and metal ions leached out of the system easily. The researchers found that the activity of SRB species in the presence of heavy metal ions such as Cu (20 mg/L), Zn (20 mg/L) and toxic chemical such as glutaraldehyde (10 mg/L) was reduced. Maeda, T., Negishi, A., Nogami, Y., & Sugio, T. (1996). Nickel inhibition of the growth of a sulfur-oxidizing bacterium isolated from corroded concrete. Bioscience, biotechnology, and biochemistry, 60(4), 626-629 suggested the possibility of using nickel to prevent concrete corrosion. It is also been reported that sodium tungstate completely inhibits the growth of thiooxidans cells [Negishi, A., Muraoka, T., Maeda, T., Takeuchi, F., Kanao, T., Kamimura, K., & Sugio, T. (2005). Growth inhibition by tungsten in the sulfur-oxidizing bacterium Acidithiobacillus thiooxidans. Bioscience, biotechnology, and biochemistry, 69(11), 2073-2080.]. Zinc oxide is also reported to have good thermal quality and color stability. In addition, zinc oxide has been use as an antibacterial agent in medicine and food packaging because of its antibacterial effect and relative safety.

Challenges associated with using heavy metals as antibacterial agents in coating materials include: short bio-resistance life time and efficiency; leachability of the antibacterial agents into the environment; safety concerns and regulations that restrict levels of certain metals in sewer systems; poor adhesion to the concrete pipe substrate; and cost. Also, in high dosages heavy metal based antibacterial agents might affect the structural properties of the coating material. Some of these heavy metals are also toxic and undesirable leaching of such heavy metals into the surrounding environment may cause corresponding problems.

### 1.3 Anti-Adhesive Layers

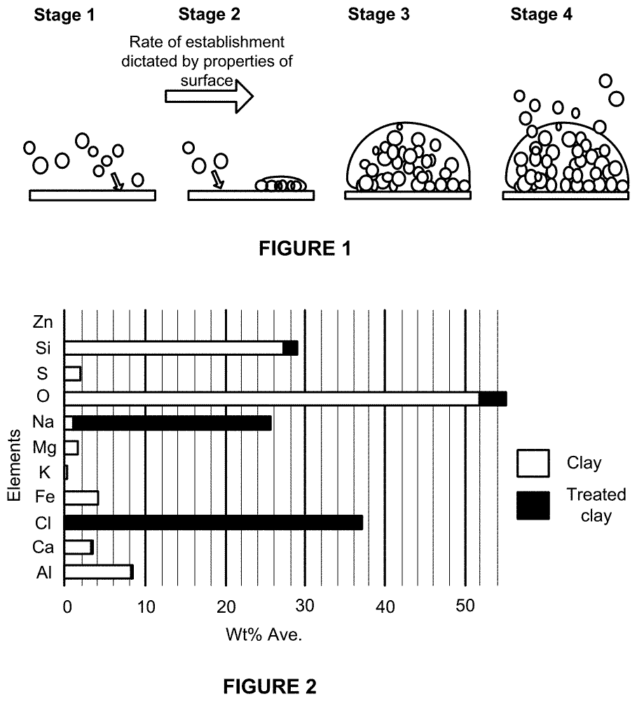

Another type of coating in use today is an anti-adhesive layer that is able to reduce the chance of microbial attachment to the concrete pipe surface. Such anti-adhesive layers include polydimethylsiloxane (PDMS) and polyethyleneglycol (PEG). Bacterial biofilm formation in concrete pipe typically starts with initial attachment and adhesion of bacteria to the concrete surface. Microbial cells aggregate on the surface and produce insoluble polymeric substance (called exopolysacharides (EPS) proteins) that encase the adherent bacteria in a three dimensional matrix, see FIG. 1. EPS help the cell to adhere to a surface, trap nutrients and protect them from antibacterials. With accumulation of EPS and reproduction of bacteria colonies develop into mature biofilm and exhibit increased resistance to removal

The chance of initial microbial attachment to the surface is typically dependent on coating material chemistry, surface topography, mechanical properties, surface hydrophobicity (surface energy), low intermolecular interaction with biomolecules, environmental conditions as well as bacterial surface structure. In addition, a surface's physical and chemical properties could have the potential to kill the bacteria upon contact. For example, cationic polymers hold positive charge that can attract bacteria with negative charge and pull such bacteria into pores causing cell rapture.

### 1.4 Long-Acting Antibacterial Agent Coatings—Techniques for Immobilizing Antibacterial Agents

### 1.4.1 Antibacterial Agent-Loaded Carriers

As discussed above in section 1.2, there are challenges involved in using antibacterial agents and their possible risks for the surrounding ecosystem. In some embodiments of the invention, antibacterial agents are immobilized inside coatings.

In some embodiments, microencapsulation may be used to immobilize antibacterial agents to gain control over the release of the antibacterial agents. In these microencapsulation methods, the compound may be retained inside a protective framework until a trigger affects its release. It is expected that microencapsulation of antibacterial agents will extend the duration of antibacterial activity.

There have been studies looking at the synthesis of polymer-nanocomposite hybrid carriers (e.g. polymers with inorganic clays or silica at nanometer scale). These inorganic-organic composites have attracted interest due to their capability of holding and controlled-delivery of various active agents. In some embodiments, antibacterial agents may be immobilized using such polymer-nanocomposite hybrid carriers.

Another potential antibacterial agent immobilizing technique, which may be used in some embodiments, involves using porous inorganic carrier particles such as amorphous silicate, amorphous alumina and zeolites having antibacterial agents adsorbed within their pore system. Zeolites are highly porous crystalline aluminosilicate minerals with uniform pores and room for biological and chemical reactions. Ions present in zeolites (such as calcium and sodium) can be exchanged, in an ion exchange process, with antibacterial agents such as silver, zinc, copper and/or other antibacterial heavy metals.

In some embodiments, nano tubes (nanometer-scale hollow cylinders) may be used as carriers for antibacterial agents.

Challenges of using antibacterial agent carriers include: potential impact of high dosage of the biocide carriers on the structural properties of the coating material (e.g. strength reduction); the dependence of the performance of antibacterial agent on the chemical and physical properties of the carrier and the carrier's compatibility with other materials; availability of carrier materials; and cost.

### 1.4.2 Antibacterial Agent Solidification in Coating Matrix

In some embodiments, antibacterial agents may be retained in the pores (3D framework) of the coating material and/or combined with, and then solidified with, the coating material. Immobilizing antibacterial agents with this technique can overcome problems with the prior art use of biocides, extend antibacterial activity, reduce health and environmental risks and modulate the release behavior of the antibacterial agents.

An example of a matrix that may be used in some embodiments to immobilize and lock heavy metals tightly in its 3D structure is geopolymer. Alkali aluminosilicate polymers or “geopolymers” are a family of minerals with cementitious properties and are amorphous three-dimensional binder materials formed by mixing alumino-silicate minerals in an alkaline activator solution.

The microstructure of geopolymers (similar to zeolites or feldspathoids) is known for an excellent ability to absorb and solidify chemicals, so geopolymers have been used as a potential matrix for waste stabilization. High Si/Al ratio in these geopolymer materials can be used to create low anionic field that gives relatively high selectivity toward cations of lower charge such as Ag²⁺, Cu²⁺and Zn²⁺and relatively low selectivity towards cations of higher charge such as Ca²⁺.

Heavy metal based antibacterial agents have the potential to be a combined part of the geopolymerized matrix structure when the geopolymer polymerizes or to be held in the voids of the porous matrix of the geopolymer material when it polymerizes. Leaching values of heavy metals from geopolymer materials may be much smaller when compared to cement-based materials. However, the upper limit of the heavy metal content which can be encapsulated in a geopolymer matrix is low and limited. That is, the geopolymer matrix can only tolerate limited amounts of heavy metal content before the matrix becomes chemically or physically unstable, which may in turn cause leaching levels to increase. The amount of heavy metals that can be encapsulated in a geopolymer matrix has been reported to be on the order of about 0.3-0.5 wt %.

### 2. Coating Modification Strategies

As described in section 1.3 below, some embodiments involve compositions comprising an antibacterial agent (e.g. biocide and/or heavy-metal based antibacterial agent) encapsulated in an antibacterial agent carrier to form a first plurality of encapsulated antibacterial agent particles. In some embodiments, the antibacterial agent may comprise zinc and the antibacterial agent carrier may comprise clay minerals (e.g. sodium bentonite clay). For brevity, such encapsulated antibacterial agent particles may be referred to herein as zinc-doped clay without loss of generality.

Table 1 summarizes the characteristics that were considered when developing the structural material compositions according to particular embodiments of the invention.

TABLE 1
Characteristics considered in developing structural material
compositions according to particular embodiments

| Coating properties | Strategy |
|---|---|
| Bio-corrosion | Using acid resistant materials |
| resistant | (e.g. non-cement based materials, Geopolymers, |
| | magnesium phosphate) |
| | Densify microscopic structure |
| | (e.g. using matrix densifiers) |
| | Adding antibacterial agents to inhibit |
| | bacterial growth |
| | (e.g. Heavy metals such as zinc-oxide) |
| | Increase pH |
| | Acid neutralizers |
| | (e.g. magnesium hydroxide) |
| Lifetime and | Embedding antibacterial agent in a carrier |
| Efficiency | (e.g. zinc-doped clay particle) |
| | Encapsulate antibacterial agents in 3D |
| | framework of coating material |
| | (e.g. encapsulate zinc-oxide in geopolymer matrix) |
| | Solidify antibacterial agent-loaded carrier in 3D |
| | framework of coating structure |
| | (e.g. solidify zinc-doped clay particles in blended |
| | geopolymer network) |
| | Increase degree of encapsulation |
| | (e.g. benefit from combining two networks with |
| | encapsulating potentials such as magnesium |
| | phosphate and geopolymer) |
| Durability and | Increase corroded pipe's service life |
| Sustainability | (e.g. restore structural integrity of corroded pipes, |
| | enhance remaining strength) |
| | Using non-toxic antibacterial agent |
| | Using energy efficient and green materials |
| | (e.g. supplementary cementitious materials |
| | such as fly ash) |
| | Contains minimal cement |
| | Good bonding and compatibility with concrete |
| | pipe surface |

According to strategies summarized in Table 1, two types of corrosion resistant coating materials with encapsulating properties were evaluated and used. The first such coating material was geopolymer and the second coating material was a blended mix of geopolymer and magnesium phosphate hydrates (also referred to as magnesium cement and/or magnesium phosphate). The aim of combining these two matrices in the second coating material was to take advantage of each system's individual strengths, adding long-lasting anticorrosion properties, increasing the degree of encapsulation and creating a denser matrix. Combining the magnesium phosphate matrix with fly ash (as a form of geopolymer matrix) could also reduce the cost of the composition and be favorable to sustainable development and environmental protection (since the fly ash is typically a recycled or by-product material).

Furthermore, the fineness of hydrated magnesium phosphate particles is much higher than ordinary Portland cement particles. Due to this fineness, magnesium phosphate reacts with water relatively quickly when compared with Portland cement. Un-hydrated magnesium particles are able to consume extra water produced during the geopolymerization process and produce magnesium hydroxide which may react with sulfuric acid and produce MgSO4 and increase the pH:

Acid-neutralization reaction of magnesium hydroxide

MgCO₃+heat→MgO+CO₂

MgO+H₂O→Mg(OH)₂

⋅Mg(OH)₂+H₂SO₄→MgSO₄ (Base, increase pH)+H₂O (1)

Two mechanisms were also considered to control the release of antibacterial agents embedded in the geopolymer coating. The first mechanism involved integrating the antibacterial agent molecules (e.g. heavy metals, such as zinc oxide) in the 3D framework of the coating binders (e.g. geopolymer and/or geopolymer blended with magnesium phosphate hydrates). The second approach involves use sodium bentonite clay impregnated with antibacterial agents (e.g. zinc ions) to provide an antimicrobial agent-loaded carrier (e.g. encapsulated antibacterial agent particles) and then combine the antimicrobial agent-loaded carrier into the structure of the coating binders (e.g. geopolymer and/or geopolymer blended with magnesium phosphate hydrates). Sodium bentonite clay is an abundant, durable and economically viable clay material. Sodium bentonite clay has high strength and biocompatibility and can be combined into geopolymer structure. Antibacterial agent-loaded clay particles (e.g. antibacterial agent particles embedded in sodium bentonite clay) have the potential to get incorporated as a secondary binding material and act as a precursor in the geopolymerization reaction.

The inventors prepared a number of different geopolymer mixes (section 4 below) these different geopolymer mixes were evaluated according to chemical stability and highest compressive and tensile strength properties. Then blended mixes of magnesium phosphate hydrate-geopolymer were prepared (section 5 below) and evaluated according to chemical stability and tensile strength properties. SEM-EDS (Energy Dispersive Spectroscopy fitted to Scanning Electron Microscope system) was used to investigate the microstructure and composition of developed materials. The most promising geopolymer and blended mixes were integrated with zinc-oxide particles Zn-doped clay particles (as described in section 3 below). Leaching and chemical stability, tensile strength, bonding and shrinkage properties were tested to evaluate the performance of the developed materials. To the inventors' knowledge, the properties and performance of blended geopolymer and multiphase composite coatings comprising integrated zinc doped bentonite clay (or other encapsulated antibacterial agent particles) has not been investigated.

### 3. Sodium Bentonite Clay Functionalized With Zinc Oxide

As discussed above, clay minerals are useful for encapsulating antibacterial agents. This may be due to the high storing capacities of clay minerals as well as their swelling and/or colloidal properties.

Clay minerals are inorganic cationic exchangers. So ion exchange takes place by mixing clay particles with other ions in a solution form. In particular embodiments, sodium bentonite clay may be impregnated with zinc ions to functionalize the combination as an antimicrobial agent (e.g. antibacterial agent encapsulated in clay or encapsulated antibacterial agent particles). Sodium bentonite clay is an abundant, durable and economically viable clay material. It has high strength and biocompatibility and can be integrated as a carrier loaded with antibacterial agents into protective coatings.

### 3.1 Pre-Treatment Methodology of Clay Minerals

In experiments conducted by the inventors, pure sodium bentonite clay, Al₂H₂Na₂O₁₃Si₄, was used as carrier material and loaded with Zn²⁺-ions via an ion-exchange process. Metal ions such as sodium in clay are exchangeable by zinc ions to functionalize the as antibacterial agent carrier.

Raw clay samples usually contain large amount of different minerals (e.g. carbonates, quartz, illite and calcite). To increase the quality and ion exchange capacity of clay particles, samples may be pretreated (also called clay enrichment). Several methods for clay enrichment may be used including, for example, carbonate decomposition, dissolution of metal oxides/silica by acid and oxidation of organic materials. In the experiments conducted by the inventors, sodium chloride solution was prepared by stirring 10 grams sodium chloride in 100 ml water. Then 10 grams of clay was stirred in 1 M, 100 mL sodium chloride solution for 24 hours. After repeating the process three times, the samples were washed with distilled water and dried at 80° C. for 1 hour.

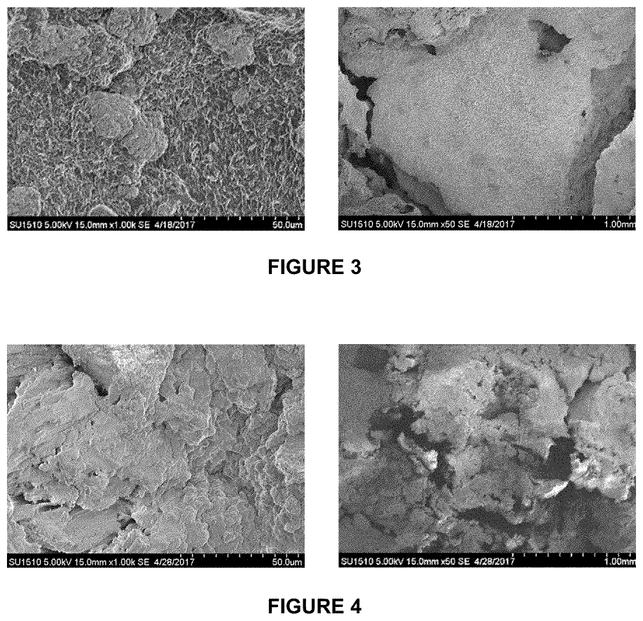

SEM-EDS analysis was used to study the morphology as well as the chemical composition of the clay before and after pre-treatment. For this purpose, samples of pre-treated and non-pre-treated clay taken and impregnated using epoxy-based resin. Then epoxy impregnated samples were cut with a saw and polished with diamond grit. Ultimately samples were cleaned in a desktop UV cleaner chamber and dried at 50° C. FIG. 3 shows SEM images of clay samples (at two different magnifications) before pre-treatment and FIG. 4 shows SEM images of clay samples (at two different magnifications) after pre-treatment. These SEM images show a typical layered structure with numerous nano-flakes of clay particles.

The results of this experiment show significant reduction in the amount of most matrix minerals after the pre-treatment process, (see Table 2 and FIG. 2) . During the pre-treatment process, clay is simultaneously activated interlayer calcium ions were replaced with sodium ions. So Ca content is reduced and Na content increased. The increase in Cl is attributable to the samples' immersion in sodium chloride solution.

TABLE 2
Chemical composition of clay before and after pre-treatment

WT %

| Element | Raw Clay | Pre-Treated clay |
|---|---|---|
| Al | 8.28 | 0.16 |
| Ca | 3.23 | 0.02 |
| Cl | 0.00 | 37.09 |
| Fe | 4.18 | 0.00 |
| K | 0.21 | 0.00 |
| N | 0.00 | 0.00 |
| Mg | 1.47 | 0.00 |
| Na | 0.95 | 24.80 |
| O | 51.90 | 3.28 |
| S | 2.02 | 0.00 |
| Si | 27.41 | 1.66 |
| Zn | 0.00 | 0.00 |

### 3.2 Ion Exchange With Zinc

Ion exchange in clays and other minerals is highly dependent on the structure of the mineral and chemical composition of the solution in contact with the mineral. Ion exchange is a reversible chemical reaction that occurs between ions near mineral surface, unbalanced electrical charges in the mineral framework and ions in the solution. The common exchangeable cation in most clay minerals is Ca⁺².

In experiments performed by the inventors, bentonite clay was subjected to an ion-exchange process by stirring 10 grams of sample in 0.01 M, 100 mL of 0.35 mol/L zinc oxide solution and stirred at 50° C. for 4 h in a dark environment, with the pH of the system maintained between 6 and 8 (made possible by adding nitric acid to the solution). Then the slurry was separated into solid and liquid by vacuum filtration. The separated solid specimen was washed by dispersion into 100 mL of distilled water and then filtrated again. The washing and filtration were repeated until there was no Zn detected in the washing solution. After that, the modified clay was dried at 90° C. for 12 h.

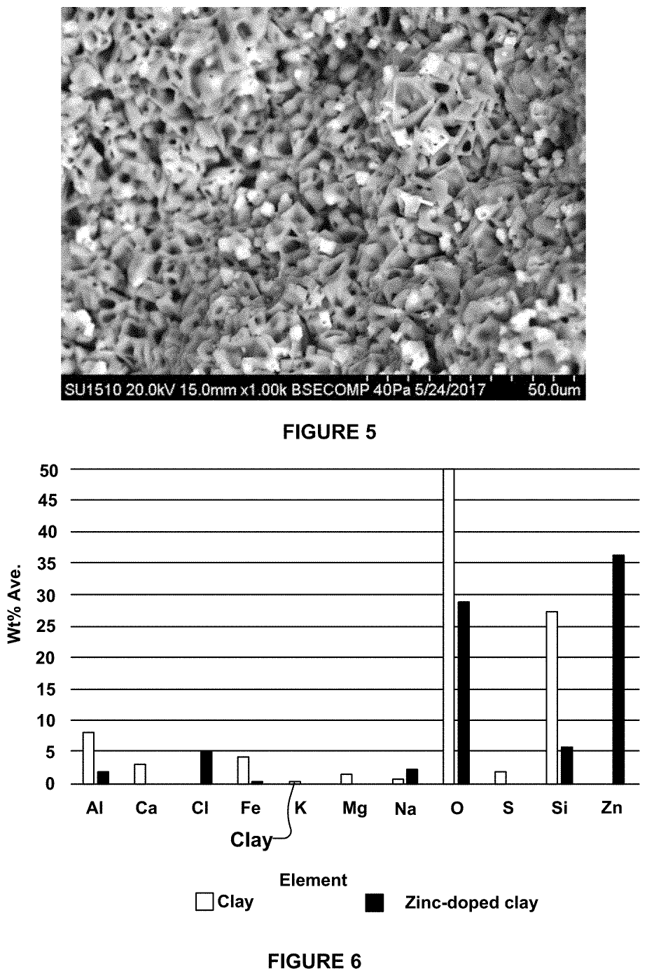

SEM-EDS analysis was used to study the chemical composition of the zinc-doped clay. FIG. 5 is an SEM image of an ion-exchanged clay sample. As can be seen from FIG. 5, after ion exchange, the impregnated zinc ions create more porous microstructure and texture, when compared to the samples (e.g. FIGS. 3 and 4) prior to ion exchange.

Results of this ion exchange process show significant increases in the amount of Zn in the system, see Table 3 and FIG. 6. Ion exchange involved the replacement of Na ions with Zn ions in the system. Table 3 also shows how Na ions replaced the Ca ions originally present in the raw clay during the pre-treatment process (see section 3.1).

TABLE 3
Chemical composition of ion-exchanged bentonite clay

| | WT % | | |
|---|---|---|---|
| Element | Raw Clay | Pre-Treated clay | Zinc-doped clay |
| Al | 8.28 | 0.16 | 2.04 |
| Ca | 3.23 | 0.02 | 0.04 |
| Cl | 0.00 | 37.09 | 5.22 |
| Fe | 4.18 | 0.00 | 0.48 |
| K | 0.21 | 0.00 | 0.00 |
| N | 0.00 | 0.00 | 0.00 |
| Mg | 1.47 | 0.00 | 0.00 |
| Na | 0.95 | 24.80 | 2.37 |
| O | 51.90 | 3.28 | 28.83 |
| S | 2.02 | 0.00 | 0.00 |
| Si | 27.41 | 1.66 | 6.08 |
| Zn | 0.00 | 0.00 | 36.49 |

### 4. Geopolymer Matrix

### 4.1 General Properties

Alkali alumino-silicate polymers or “geopolymers” are a family of minerals with cementitious properties. Geopolymers are amorphous three-dimensional binder materials formed by mixing alumino-silicate minerals or industrial byproducts rich in SiO₂ and Al₂O₃ (e.g. fly ash (e.g. fly ash type F), slag, metakaoline and/or the like) with an alkaline activator solution (e.g. NaOH). Alkaline liquid is used to react with the silicon and aluminium and forms the geopolymer paste. The alkaline activation is a chemical process in which partially or totally amorphous structures change into compact cemented frameworks.

When these two components, alumino-silicate solids and the alkaline activation solution react, alumino-silicate materials are rapidly dissolved into the strong alkaline solution to form free SiO₄ and AlO₄ units. These units are then polymerized together and form polymeric precursors (—SiO₄—AlO₄— or —SiO₄—AlO₄—SiO₄ or —SiO₄—AlO₄—SiO₄—SiO₄—).

Geopolymerization can also be described in terms of a polymeric model similar to some zeolites. Both Al and Si found in the geopolymer are tetrahedrally coordinated and the alkali (e.g. Na) may be housed in the voids of the three dimensional frame work.

Depending on the source of the alum ino-silicate material, particle size and processing conditions, geopolymers can exhibit a wide variety of properties and characteristics including high early strength, low shrinkage, fast setting and high acid and fire resistance. In some embodiments, fly ash is a currently preferred alumino-silicate source material for geopolymer production. To produce optimal binding properties, the fly ash may exhibit one or more of the following properties: loss on ignition (LOI) less than 5 wt %; Fe₂O₃ less than 10 wt %; and silica content of 40-50 wt %. Calcium content, amorphous content and morphology of the fly ash may also affect the initial mix properties as well as final structure of fly ash-based geopolymers.

In addition to the source of alumino-silicate material, there are several other parameters which may impact geopolymer properties. Curing temperature, curing time and alkaline liquid concentrations are factors relevant in the geopolymerization reaction and may impact the mechanical strength of the resultant geopolymer. Water to fly ash ratio, CaO content, Si/Al and Na₂SiO₃/NaOH ratios are also parameters that impact the properties of the resultant geopolymers. Some of these relevant factors are summarized in Table 4.

An increase in fly ash content and alkaline activator concentration may ipact the mechanical properties of the geopolymer due to the increase in sodium oxide content that is required for geopolymerization reaction. However, by increasing the Na₂SiO₃/NaOH ratio to more than 3, excess OH⁻ concentration may be produced, which may reduce the compressive strength of the geopolymer. Moreover, the excess sodium content may form sodium carbonate which may in turn disrupt the geopolymerization process. It has been reported in the literature that the highest compressive strength of geopolymr was observed at fly ash/alkaline solution ratio of 2 and Na₂SiO₃/NaOH ratio of 2.5. The ratio of sodium silicate to sodium hydroxide solution that were used by other researchers is between 0.4 to 2.5 (by mass).

The most common alkaline activators comprise a mixture of sodium silicate (Na₂SiO₃) or potassium silicate (K₂SiO₃) and sodium hydroxide (NaOH) or potassium hydroxide (KOH). The type of alkaline solution may be a factor affecting the mechanical strength of the geopolymer. The literature has reported that the combination of sodium silicate and sodium hydroxide gave the highest compressive strength in producing fly ash geopolymers.

When the alkaline activator solution is NaOH, the produced sodium aluminosilicate gel has an Si/Al ratio of around 1.6-1.8 and the Na/Al ratio is around 0.46-0.68. By adding Na₂SiO₃, in the presence of silicate ions, the content of Si ions in the N-A-S—H bond increases. So the ratio of Si/Al rises to around 2.7 and Na/Al to 1.5. This increase in ratios may enhance condensation degree and mechanical strength of the resultant geopolymer. An increase in alkalinity may result in a shorter final setting time and higher strength.

The CaO content of fly ash may play a significant role in enhancing the setting time, final hardening, strength development and/or mechanical properties of geopolymer products. According to the American Society for testing and materials, fly ash can be categorized into class F and C. Class F which is low calcium fly ash, characterized by a combination of SiO₂+Al₂O₃+Fe₂O₃>70 wt % and SO₃<5 wt %. Class C fly ash is characterized by a combination of SiO₂+Al₂O₃ +Fe₂O₃<70 wt % and high Ca and Mg contents (e.g. around 27 wt % and 3.8 wt % respectively). The Canadian Standards Association (CSA) classified fly ash as Type F, Cl or CH based on the calcium oxide (CaO) content of the fly ash. Type F has CaO content of up to 15 wt %, Type Cl between 15 wt % and 20 wt %, and Type CH greater than 20 wt %. In particular embodiments, low calcium fly ash is currently preferred (relative to higher calcium fly ash) to optimize binding properties, reduce the risk of fast setting and increase durability of the resultant geopolymer in acidic environments, low calcium fly ash is more preferable than high calcium fly ash. In some embodiments, the geopolymer may exhibit other characteristics, such as unburned material lower than 5 wt %, Fe₂O₃ not higher than 10 wt % and reactive silica content of 40-50 wt %. In addition, since low-calcium geopolymer chemistry is not based on calcium-aluminates which are subjected to sulfate attack, low-calcium geopolymer materials have the potential to be an economic solution which enhance resistance to acidic environments compared to cement-based coatings.

TABLE 4
Factors affecting fly ash-based geopolymer mix design

| Factor | | Note |
|---|---|---|
| Activator | NaOH | Crystalline geopolymer prepared with |
| Type | (Molarity 8-20) | sodium hydroxide is very stable in |
| | | acidic environment |
| | | Compressive strengths at 28 days of |
| | | 20-23 MPa is obtained with NaOH 9.5- |
| | | 14M. NaOH concentration beyond this |
| | | point reduce strength due to early |
| | | precipitation of aluminosilicate products |
| | NaOH and | Water glass/NaOH = 0.5 and slag |
| | water glass | reported with around 38 Mpa |
| | | compressive strength after 28 days in |
| | | ambient temperature |
| | NaOH and | Na₂SiO₃/NaOH = 2-2.5 is recommended |
| | Na₂SiO₃ | Higher NaOH increase pH condition |
| Activator/fly | 0.3-0.6 | Activator/ fly ash ratio of 0.3-0.6 is |
| ash | | recommended |
| Calcium | CaO <5 wt % | Low CaO content 3-4wt % is |
| content | | recommended |
| | CaO >5 wt % | Higher CaO leads to lower acid |
| | | resistance potential and higher strength |
| Fly ash type | F | Fly ash type F (CaO 2 wt %) has 10% |
| | C | mass loss in pH less than 1, fly ash type |
| | blend | C (CaO 20 wt %) has around 25 wt % |
| | | mass loss. |
| Cement | 5 wt % | Cement addition reduces setting time, |
| additive | 10 wt % | porosity and enhances compressive |
| | 15 wt % | strength, increases hydration products. |
| | | Hydration liberated heat promotes |
| | | geopolymerization process |
| Curing | Wrapped in | lower porosity |
| condition | plastic | |
| (ambient | Immersed in | In case of having high CaO content or |
| temperature) | water | cement as additive, this curing condition |
| | | gives higher strength but also higher |
| | | porosity |
| Setting time | 85 wt % | Reduces compressive strength slightly |
| retarder | phosphoric acid | |

Geopolymers are affected by sulfuric acid corrosion in different ways compared to Portland cement mortars. The first impact of sulfuric acid corrosion on geopolymers involves the formation of gypsum out of the CH present in the paste. The second impact of sulfuric acid corrosion on geopolymers is by leaching of the alkaline elements (e.g. sodium or potassium) after diffusion of the SO⁻² ions in the network. However the alumino-silicate network remains unaffected and the geopolymer can retain a great percentage of its structural strength after acid attack [Song et al., 2005].

Microorganisms and biogenic sulfuric acid attack is also influenced by diffusion mechanisms in geopolymers. Amounts and connectivity of the capillary porosity affect the penetration of aggressive ions into the matrix. So reducing the permeability could make it harder to for movement of fluids and acid-producing microorganisms through the system. A low permeability network is not immune to bio-corrosion, but it suffers from chemical attack only on the surface (rather than on the surface and in the interior body) and, consequently, lasts longer.

As discussed elsewhere herein, geopolymers also have the potential to encapsulate heavy metals either physically (charge balancing of Al in framework) or chemically (covalent bonds) within the three-dimensional alumino-silicate network.

Geopolymers may be able to store heavy metals, such as Zn²⁺, Cu²⁺, Cr³⁺, Cd²⁺and Pb²⁺, with minimum losses in strength. Geopolymers can embed Cu ions among the pores of the structure in the uncombined forms such as Cu(OH)₂ and CuO. So the ability of geopolymers to encapsulate antibacterial agents (e.g. heavy metals and/or other biocides) could have great opportunity for creating control-released antibacterial coatings.

### 4.2 Mix Design and Sample Preparation

In their experiments, the inventors used fly ash type F according to ASTM classification which originated from Centralia power plant. The physical and chemical composition of this fly ash is set out in Table 5. As can be seen, the silicon and aluminum constitute about 60% of the total mass and the ratio of silicon to aluminum oxide is about 2.4.

TABLE 5
Physical and chemical composition (wt
%) of fly ash used in this study

| | |
|---|---|
| Silicon Dioxide (SiO₂) | 42.20% |
| Aluminium Oxide (Al₂O₃) | 16.90% |
| Iron Oxide (Fe₂O₃) | 6.20% |
| SiO₂ + Al₂O₃ + Fe₂O₃ | 65.30% |
| Sulphur Trioxide (SO₃) | 1.40% |
| Calcium Oxide (CaO) | 18% |
| Magnesium Oxide | 4.80% |
| Moisture content | 0.10% |
| Loss on Ignition (L.O.I) | 0.26% |
| Available Alkali as Equiv. Na₂O | 1.02% |
| Fineness retained on sieve no. | 13.90% |
| Density | 2.67 Mg/m³ |

In some experiments conducted by the inventors, a combination of sodium silicate and sodium hydroxide was chosen as the activating alkaline. Sodium silicate solution contains (wt %) water=55.9%, sodium silicate salt=44.1%. The other characteristics of the sodium silicate solution are specified as SiO₂/Na₂O≈2 and specific gravity of around 1.53 gr/cm³.

The sodium hydroxide solutions were prepared in two concentrations by dissolving sodium hydroxide pellets in water. So, for example, 12 Molar NaOH solution comprise 12×40 (NaOH molecular weight) which is equal to 480 gr of NaOH solids per 1 liter of solution.

The alkali activator solution was prepared by mixing sodium hydroxide solution and sodium silicate according to the mix design provided in Table 6 one day before casting. A constant alkaline activator ratio of NaSiO_{2/}NaOH≈2.5 and fly ash/alkaline activator≈2.8 was considered in most of the mixes for the ease of comparison.

At the beginning, numerous trial mixtures of geopolymer concretes were manufactured in cylindrical moulds (100×200 mm). An eighty litre capacity pan mixer available in the SIERA concrete laboratory for making ordinary Portland cement was used for producing the geopolymer paste. Preliminary laboratory work involved familiarizing the inventors with casting fly ash based geopolymer, understanding the effect of the sequence of adding alkaline solution to the solids constituents, understanding the basic mixtures proportions, observing the behaviour of the mix and developing a consistent process of mixing and curing. Details of different batches with different mixture proportions is summarized in Table 6.

The casting and mixing procedure consisted of first mixing sodium silicate solution and the sodium hydroxide solution together at least one day prior to use. In some embodiments, to assist the polymerization process and reduce the chance of bleeding and segregation of the paste, the sodium hydroxide and sodium silicate solution were mixed with one another before mixing the alkaline activators with the dry contents. For example, in some embodiments, the dry material was mixed for 3 minutes, and alkaline activator was slowly added and mixed for about 1 min, after which the water was added and while continuing to mix for another 1 min. Geopolymerization is a relatively fast reaction—e.g. initial setting occurs in less than an hour. Adding water to the system after 1 min made the mix more workable and retarded the formation of alumino-silicate network.

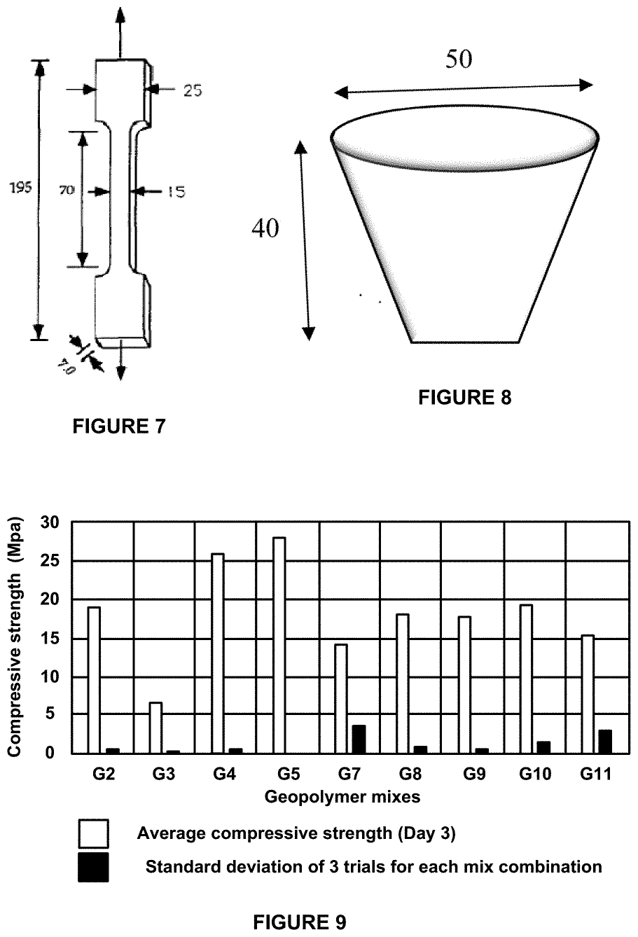

After mixing, the samples were cast in cylindrical plastic moulds (75 mm diameter by 150 mm high) and compacted by applying ten manual strokes per layer in three equal layers followed by compaction on a vibration table for ten seconds. Samples were also prepared for SEM-EDS, chemical stability and tensile strength tests, see FIGS. 7 and 8.

After casting, all test samples were covered (using a plastic sheet) and left at ambient conditions. The specimens were demolded after 24 hours and stored at ambient temperature until the date of testing. After evaluating the compressive and tensile properties of the 11 batches (G1-G11 as set out in Table 6), the best mixes were selected for SEM-EDS and chemical stability tests.

TABLE 6
Geopolymer mix design used in experiments

| | G 1 | G 2 | G 3 | G 4 | G 5 | G 6 | G 7 | G 8 | G 9 | G 10 | G11 |
|---|---|---|---|---|---|---|---|---|---|---|---|
| Activator/Fly ash | — | — | — | — | — | — | 0.35 | 0.35 | 0.35 | 0.35 | 0.4 |
| (NaOH 14 M) | | | | | | | | | | | |
| Activator/Fly ash | 0.35 | 0.35 | 0.3 | 0.4 | 0.4 | 0.3 | — | — | — | — | — |
| (NaOH 12M) | | | | | | | | | | | |
| Sodium Silicate/ | 2.5 | 2.5 | 2.5 | 2.5 | 2.5 | 2.5 | 2.5 | 2.5 | 2.5 | 2.5 | 2.5 |
| Sodium hydroxide | | | | | | | | | | | |
| Slag/Fly ash | — | — | — | — | 0.1 | 0.1 | — | — | — | — | — |
| Silica fume/Fly ash | — | — | — | — | — | — | — | — | 0.05 | 0.1 | 0.05 |
| Water/Fly ash | 0.25 | 0.09 | 0.25 | 0.09 | 0.09 | 0.09 | 0.1 | 0.09 | 0.09 | 0.09 | 0.1 |

### 4.3 Compressive Strength

Compressive strength tests on hardened fly ash based geopolymer were performed on a Forney machine in accordance to ASTM C35 standards. From each batch of geopolymer at least three cylinders were tested.

At ambient temperature, the reaction of fly ash is relatively slow and also water evaporates slowly which led to lower compressive strength after 7 days. The higher the ambient temperature, the higher is the compressive strength. Based on the test results, geopolymer mortar develops sufficient strength even in ambient temperature conditions without any conventional curing which is an encouraging outcome for using geopolymer in some applications such as pipe repairs. A 14 day compressive strength of 25-28 MPa was obtained in the experiments conducted by the inventors with NaOH concentration in a range of 8 and 14 M (see FIG. 9).

The amount of water in the geopolymer mix may play a role on behavior, workability and strength of the material. The role of water in geopolymerization is to improve the workability which leads to an increase in porosity due to the evaporation of water during the curing process. Ultimately, the presence of too much water tends to reduce the strength of the geopolymer samples.

The mixes with higher amounts of water were more workable. However, segregation occurred when the mixing time was too long in mixes with higher water content, resulting in reduced compressive strength—see Table 6 and FIG. 9.

In batches G5 and G6, 10 wt % of the fly ash content was replaced with slag to investigate the effect of additional Ca in the system. The increased Ca induced faster initial setting and decreased the workability of the mix. The geopolymeric binder formed in the presence of slag is similar to the geopolymeric binder found in the absence of slag, which may be explained by the coexistence of hydration and the geopolymerization reaction. The faster setting time may also be due to the presence of calcium in the solid material, which may provide extra nucleation sites for precipitation of dissolved species and cause rapid hardening.

According to the results, replacing 10 wt % fly ash with slag increased the compressive strength slightly by around 5 wt %. The calcium dissolved from the slag takes part in the formation of amorphous CSH gel. However, because of the high concentration of NaOH, there is an excess amount of hydroxides present in the system and so the precipitation of calcium hydroxide in the form of Ca(OH)₂ will be encouraged. The precipitation of calcium hydroxide may prevent or mitigate the formation of CSH gel within a geopolymeric binder and so the compressive strength may not increase significantly.

Moreover, in low alkalinities the formation of CSH gel within a geopolymeric binder could work as a micro-aggregate, such that the resultant binder is more homogeneous and dense. Coexistence of both geopolymeric gel and CSH gel could also help to bridge the gaps between the different hydrated phases and unreacted particles. However, adding a Ca source to the system may affect the overall acid resistance properties. In higher alkalinities, the geopolymeric gel may be dominant and the calcium may play less significant role in affecting the nature of the resultant geopolymer. Therefore, the dissolution of calcium species may not have major impact on the ultimate strength.

Depending upon the alkalinity of the system, it is also possible that as the calcium concentration increases, the formation of geopolymeric gel and CH gel start to compete against each other. Therefore, instead of having one phase acting as a micro-aggregate to fill voids and holes of the binder, the two reactions are competing for soluble silicates and available space for growth. Consequently, the resultant binder may be disordered with two phases of similar size, and more residual holes may be produced resulting in strength reduction.

The effects of adding silica fume (5wt % and 10 wt %) to the geopolymer mortars were investigated in batches G9, G10 and G11. These batches yielded a workable mix and strength enhanced in comparison to batch G7.

As discussed elsewhere herein, the alkali activating solution is important for dissolving of Si and Al atoms to form geopolymer precursors. The compressive strength increases with an increase in fly ash content and alkaline activator concentration which is because of the increase in sodium oxide content that is involved in the geopolymerization reaction.

### 4.4 Uniaxial Tensile Test

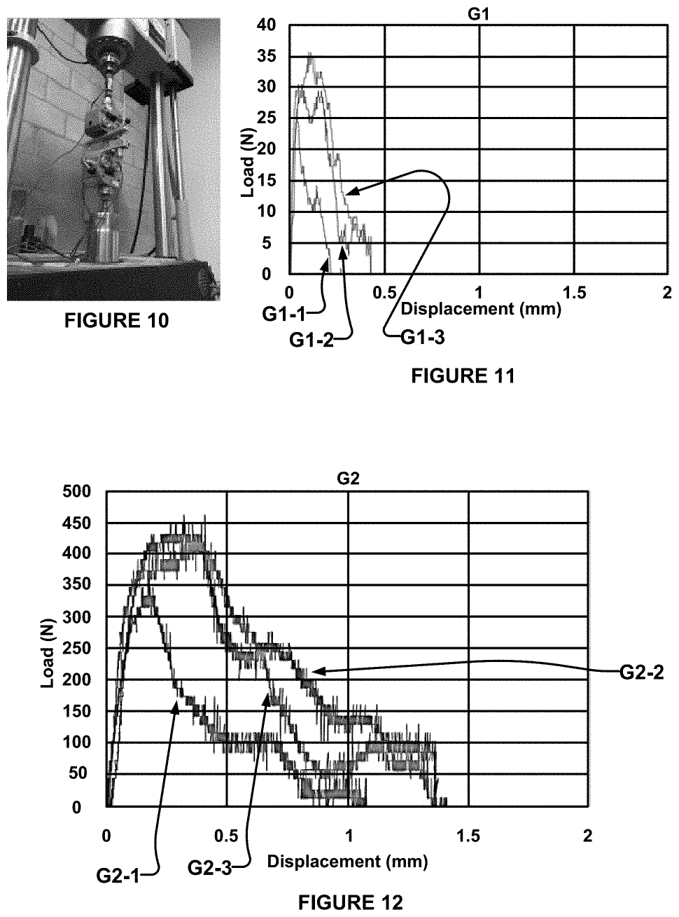

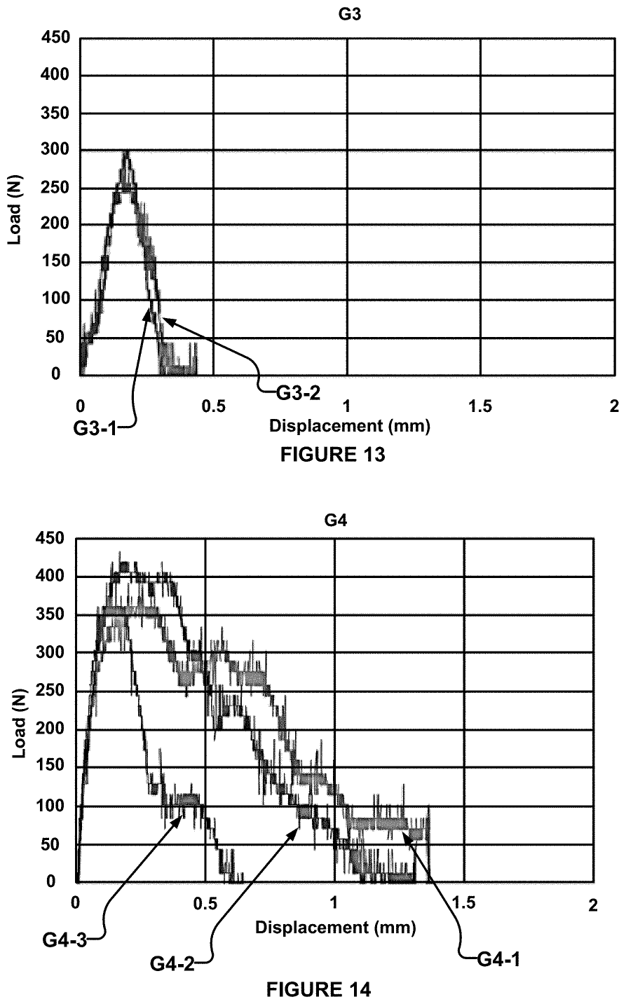

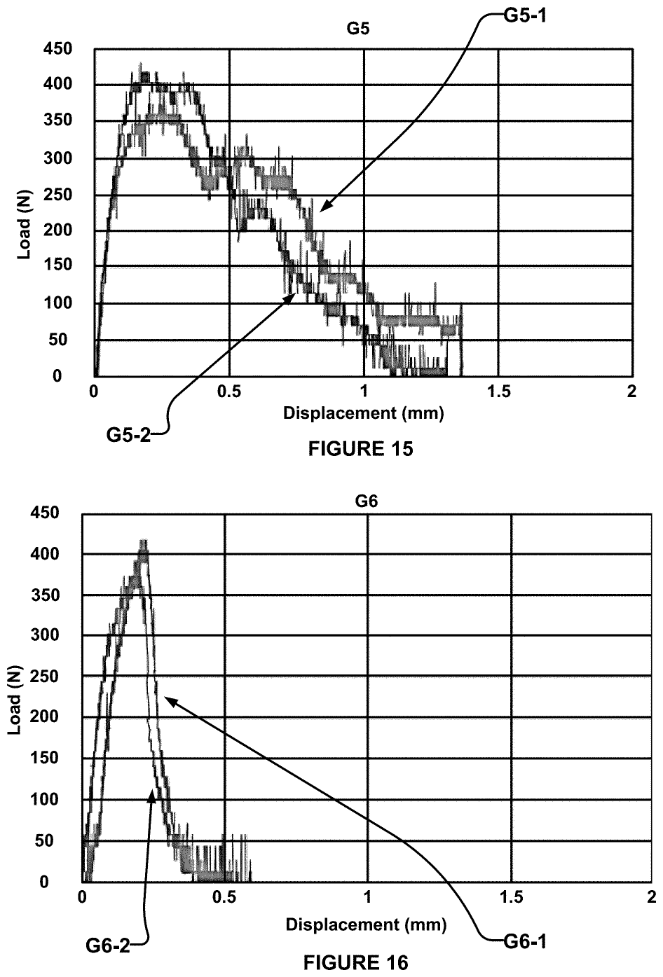

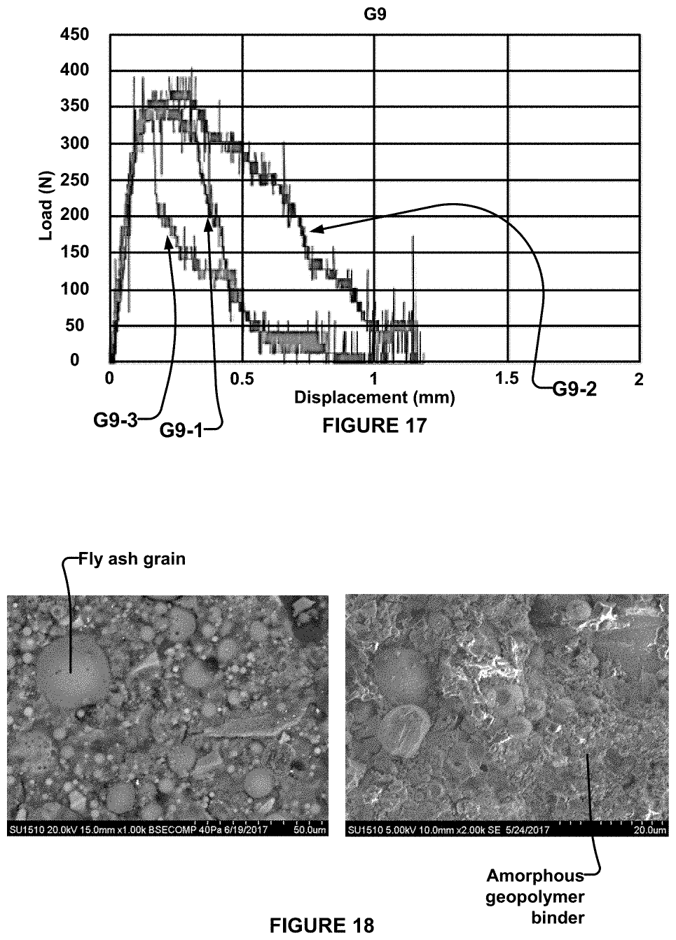

Uniaxial tensile testing was performed on 11 different batches of fiber reinforced geopolymer (0.1 wt % PVA fiber was used) (see batches G1-G8 in Table 6). A closed-loop controlled Instron testing system was used in displacement controlled mode—see FIG. 10. The testing gauge length was 60 mm and loading rate set at 0.001 mm/min. Typical load-deflection curves are presented in FIGS. 11 to 17.

According to the results, it could be concluded that addition of extra source of Ca to the mix enhances tensile properties. According to the chemistry of geopolymerization, the reaction releases water and most of this water resides within the cavities of the system until it evaporates. So if the samples are not cured in high temperature, the system may benefit from the hydration reaction of the Ca sources and CH production to enhance the tensile strength. Furthermore, the hydration process can provide heat for accelerating the geopolymerization rate.

The incorporation of silica fume (fiber) in geopolymer mortar has the potential to enhance the strength by decreasing the porosity, resulting in a denser structure and absorbing extra water in the system. Mechanical properties of the geopolymer may become increasingly elastic with increasing SiO₂ content, also the behavior may become more ductile rather than brittle. Since the amount of the fiber used was very small, deflection hardening was not observed in any of the samples.

Based on the results of compressive and tensile properties of geopolymer samples, it could be concluded that there is not much improvement in compressive or tensile strength of the samples with 10 wt % slag. There were significant improvements in the strength when the amount of the water was reduced.

Samples with activator/fly ash ratio of 0.4 showed better flexibility and higher ultimate strength compare to other samples. Overall, batches G4, G2, G5 and G9 indicated better tensile performance compare to other geopolymer mixes. G2 and G9's compressive strength is lower than G4 and G5.

### 4.5 Microstructure

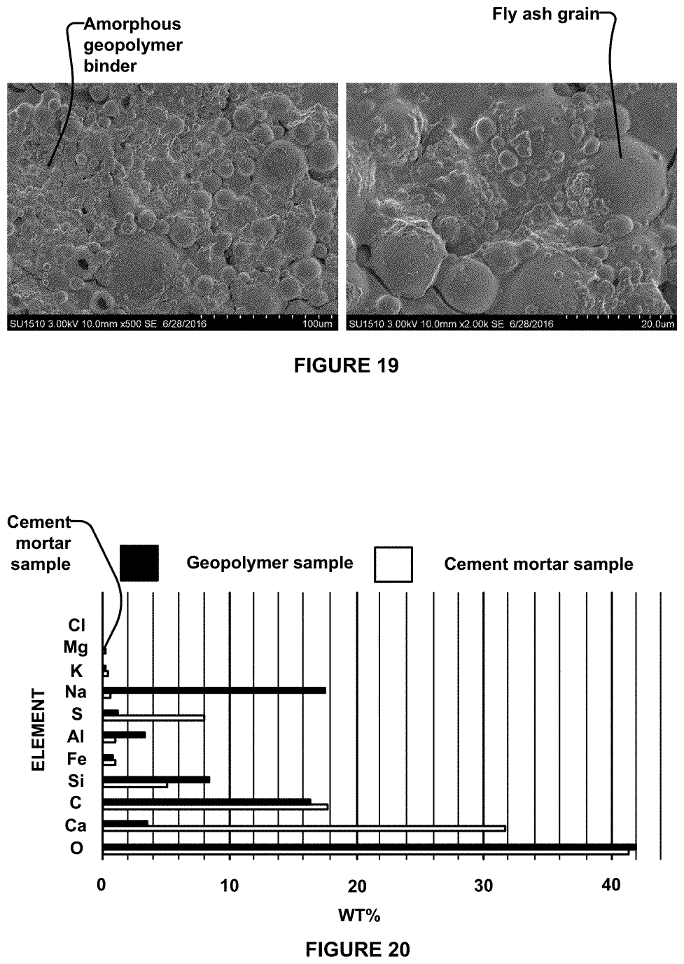

SEM-EDS was used to investigate the microstructure and composition of the geopolymer samples. For this purpose, the samples were impregnated using epoxy-based resin. Then, the epoxy impregnated samples were cut with saw and polished with diamond grit. Ultimately samples were cleaned and dried at 50° C. FIGS. 18 and 19 are SEM images of geopolymer sample (batches G4 and G5 from Table 6). Analysis was conducted at magnifications of 500, 1000 and 2000 at 30 points.

SEM-EDS analysis of geopolymer sample is shown in FIG. 20. Geopolymer samples have a condensed structure and mainly comprise O, Si, Na, Al in contrast with cement mortar samples which mainly comprise O, Ca, Si, Mg and S. The elemental distribution pattern also shows that the voids contain a high level of C that could be due to carbonation on the surface of the specimens.

A significant difference between geopolymer and cement mortar is in the wt % of Ca and Na. The presence of sodium cations in the geopolymer mix reduces the solubility of calcium ions, but tends to promote the solubility of silicate and aluminate. In small concentrations, the former effect is dominant and in large concentrations the latter effect becomes dominant. For this reason, KOH or NaOH may be used as alkaline solution and activator for geopolymerization process. So using large concentration of NaOH has some benefits, including promoting solubility of silicate and aluminate ions. In addition more OH⁻ ions tend to increase alkalinity and acid resistant properties.

### 4.6 Chemical Stability

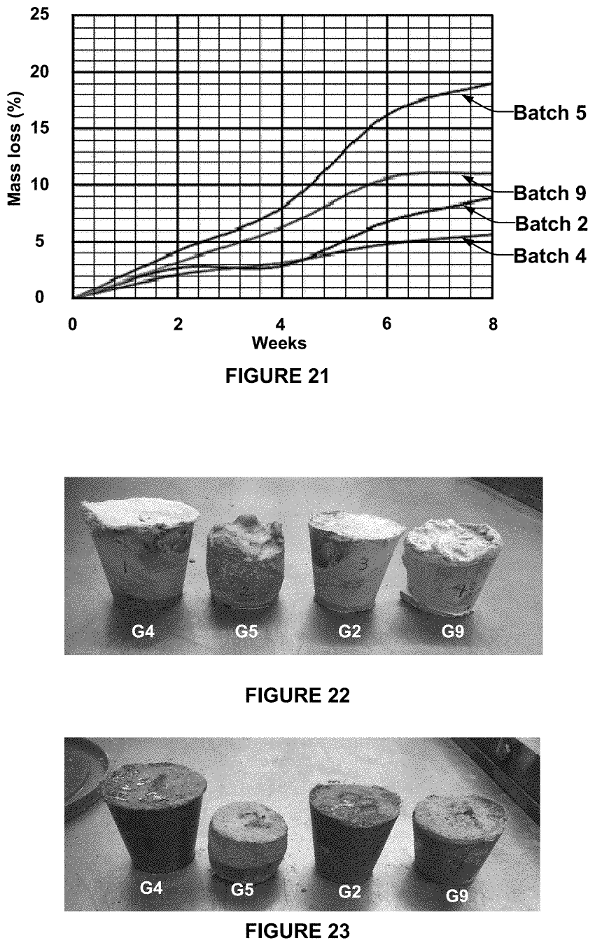

To study the resistance of geopolymers to acids, geopolymer specimens were immersed in acid solution with pH of 1.5. The changes in weight of the specimens, and the appearance of the specimens were monitored after two months. Sulfuric acid solution was prepared by diluting 99% sulfuric acid with distilled water to form concentration of 1 and pH of around 1.5. Small samples were cast (batches G2, G4 ,G5 and G9 according to Table 6) and immersed in the sulfuric acid solution. Mass loss was recorded every 2 weeks for 2 months, the results are shown in FIG. 21.

It can be seen that G4 and G9 displayed almost similar trends over the 2 month period, with max mass loss of between 5 to 10%. However G2 showed higher mass loss which may be explainable according to its higher calcium content compared to other specimens. This demonstrates that higher CaO content may provide higher strength, but also exhibits lower corrosion resistance.

The visual appearance of geopolymer specimens following 6 weeks and 8 weeks immersion in acid is shown in FIGS. 22 and 23. G5 exhibited severe erosion and significant dimensional change happened in the upper part of the sample. Leaching is clear on the surface of the samples after 6 weeks. G4 shows very small alteration in the visual appearance, color change and erosion. It may y be concluded that geopolymers are a durable solution in acidic environments.

### 5. Multiphase Matrix Integrated With Zn-Doped Clay

### 5.1 General Properties

Because of its relatively high chemical stability and acceptable mechanical properties, batch G4 described above in section 1.4 was chosen as a base material/matrix for further development of an antibacterial coating material. The base material was modified as described in this section to add antibacterial properties to the system and to immobilize the antibacterial agent in base material.

For enhancing strength, adding neutralizing effect and densifying the microstructure, in some embodiments, a blended mix of magnesium phosphate hydrates phase (also referred to herein as magnesium cement and/or magnesium phosphate) may be added to the geopolymer matrix. The inventors conducted a number of experiments to evaluate this combination of matrices. Combining these two matrices may take advantage of each matrix's individual strength and may increase the degree of encapsulation of the carrier doped with antibacterial agent (e.g. Zn-doped clay).

A magnesium phosphate binder on which the inventors conducted experiments and which may provide the second matrix comprises a mixture of magnesium oxide and potassium phosphate. The magnesium cement reaction product using this magnesium phosphate binder is magnesium dihydrogen phosphate with high early strength, high adhesive properties and fast setting time. The fineness of hydrated magnesium phosphate particles is significantly finer than ordinary Portland cement particles and so magnesium phosphate reacts much faster with water. Advantageously, un-hydrated magnesium oxide particles may be able to consume extra water produced during the geopolymerization process and may produce magnesium hydroxide which could react with sulfuric acid and produce MgSO₄ and so may increase the pH.

Zinc oxide was used as an antibacterial agent for the ultimate coating material. Two mechanisms were considered to control the release of heavy metals embedded in the ultimate coating material. The first mechanism involves keeping the heavy metal molecule (e.g. zinc oxide) in the 3D framework of the coating binders. The incorporation of the heavy metal into the matrix of the binders may happen either physically (through charge balancing of Al in the network) or by creating covalent bonds between the heavy metal and silicate chain or hydroxide links.

The second mechanism was to use sodium bentonite clay impregnated with heavy metal (e.g. zinc) ions to functionalize the resultant heavy metal doped clay as an antibacterial agent and then to combine the heavy metal doped claim into the structure of the coating materials (blended geopolymer), see section 1.3 for detailed information. Heavy metal doped clay particles have the potential to get incorporated as a secondary source of alumino-silicate in the geopolymerization reaction. However clay has lower surface area for the geopolymmerization reaction compared to fly ash which has spherical-shaped particle. So, using heavy metal doped clay particles alone may produce a weak structure.

Ten blended mixes of magnesium phosphate hydrate-geopolymer (as described in Table 7) were prepared and evaluated according to their chemical stability and tensile strength properties. SEM-EDS was used to investigate the microstructure and composition of the resultant materials. Then the best magnesium phosphate hydrate-geopolymer mixes were integrated with zinc-oxide particles and Zn-doped clay particles. Leaching and chemical stability, bonding and shrinkage properties were tested to evaluate the performance of the developed materials.

### 5.2 Mix Design and Sample Preparation

Ten blended mixes of zinc-doped magnesium phosphate hydrate-geopolymer (as described in Table 7) were prepared and evaluated in experiments conducted by the inventors.

The alkali activator solution was prepared by mixing sodium hydroxide solution and sodium silicate according to the mix design one day before casting. A constant alkaline activator weight ratio of NaSiO₂/NaOH=2.5 and fly ash/alkaline activator weight ratio=2.8 were considered in all of the mixes according to the results described in section 1.4.

Numerous trial mixtures were prepared. An eighty litre capacity pan mixer for making ordinary Portland cement was used for producing the blended paste. The casting and mixing procedure comprised first mixing the alkaline activator solution, then mixing the dry material for 3 minutes, and slowly adding the alkaline activator to the dry material mix. Ultimately water was added and mixing continued for another minute. Adding water to the system made the mix more workable and retarded the formation of the alumino-silicate network. More water was typically used for casting the blended mix when compared to geopolymer mixes. Also, more alkaline activator solution was typically used when using zinc-doped clay particles. The setting time was observed to be much faster compared to typical mixes of cement paste and geopolymer.

Different ratios of Mg/potassium phosphate were also tested. Increasing magnesium content in the mix resulted in an accelerated setting reaction due to a higher pH and therefore a faster reaction between MgO and potassium phosphate. So, sodium borate (borax) was used to reduce the setting time. However, addition of too much sodium borate tended to have an adverse effect on the mix, so, in some embodiments, the sodium borate/MgO weight ratio may be in a region around 0.08. After mixing, samples were prepared for bonding, shrinkage, SEM-EDS, chemical stability and tensile strength analysis.

TABLE 7
Mix design of composite coating in experiments conducted by the inventors

| | M1 | M 2 | M3 | M4 | M5 | M6 | M7 | M8 | M9 | M10 |
|---|---|---|---|---|---|---|---|---|---|---|
| Alkaline activator/ | 0.45 | 0.45 | 0.45 | 0.45 | 0.45 | 0.45 | 0.45 | 0.45 | 0.7 | 0.7 |
| Alumino-silictae | | | | | | | | | | |
| Sodium silicate/ | 2.5 | 2.5 | 2.5 | 2.5 | 2.5 | 2.5 | 2.5 | 2.5 | 2.5 | 2.5 |
| Sodium hydroxide | | | | | | | | | | |
| Water/binder | 0.1 | 0.2 | 0.2 | 0.25 | 0.1 | 0.25 | 0.25 | 0.25 | 0.25 | 0.25 |
| MgO + Potasium | 0 | 0.15 | 0.2 | 0.3 | 0 | 0.15 | 0.15 | 0.1 | 0 | 0.1 |
| Phosphate/Fly ash | | | | | | | | | | |
| MgO/Potassium | 0 | 1.5 | 1.5 | 1.5 | 0 | 1.5 | 1.5 | 1.5 | 0 | 1.5 |
| Phosphate | | | | | | | | | | |
| Sodium borate/MgO | 0 | 0.05 | 0.05 | 0.05 | 0 | 0.05 | 0.05 | 0.05 | 0 | 0.05 |
| ZnO/Fly ash | 0 | 0 | 0 | 0 | 0.15 | 0.15 | 0.2 | 0 | 0 | 0 |
| Zinc-doped clay/ | 0 | 0 | 0 | 0 | 0 | 0 | 0 | 0.4 | 0.5 | 0.5 |

### 5.3 Tensile Strength Properties

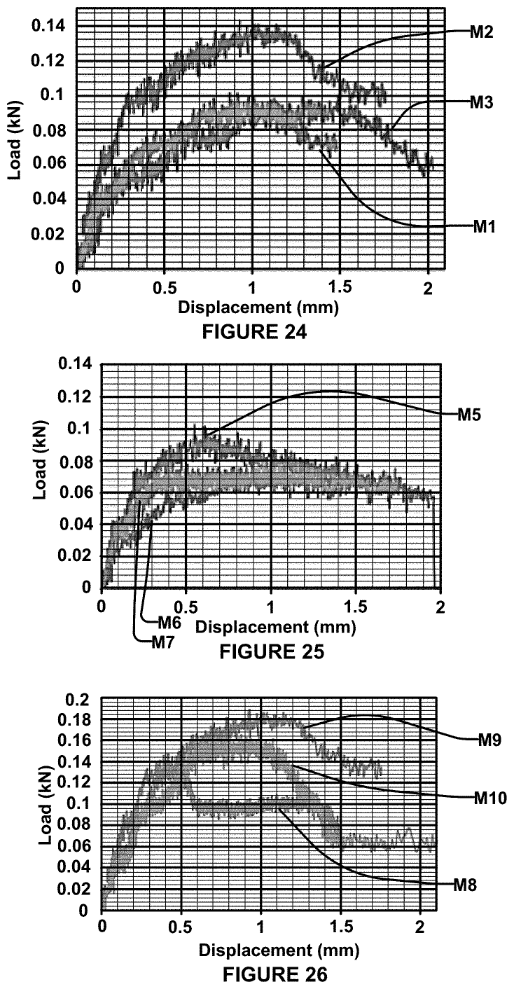

Uniaxial tensile tests were performed on each mix design. A closed-loop controlled Instron testing system was used in displacement controlled mode. The testing gauge length was 60 mm, loading rate set at 0.001 mm/min. Load-displacement curves are presented in FIGS. 24, 25 and 26.

By comparing the M2, M3 and M4 mixes (FIG. 24), it may be observed that replacing more than 15 wt % geopolymer matrix with magnesium phosphate hydrate reduces tensile strength. When magnesium oxide and potassium phosphate react, water soluble magnesium dihydrogen phosphate forms as a reaction product, which may act as a micro-aggregate in geopolymeric network. This may densify the ultimate coating material, increase encapsulation properties and strengthen the matrix. However, the geopolymeric gel could also act as a dominant product and MgO play less role in affecting the nature of the ultimate coating material. In this case the dissolution of MgO species will not have major impact on the ultimate strength.

It is also possible that as the MgO concentration increases, the formation of geopolymeric gel and hydrated magnesium gel start to compete against each other. Therefore, instead of having one phase acting as a micro-aggregate to fill voids and holes of the binder, the two reactions compete for available space for growth. Consequently, the resultant material may be a weak paste with two phases of similar size. Although the paste may have high corrosion resistant and encapsulating properties, the strength reduction will be significant.

According to the results obtained from comparing mixes M5, M6 and M7 (FIG. 25) in the experiments conducted by the inventors, it may be concluded that adding heavy metal to the geopolymer and blended paste reduces ultimate tensile strength. The performance of the blended mix with the addition of zinc oxide powder was poor compared to other mixes. The inventors posit that the zinc oxide powder absorbed a significant amount of water and left the MgO particles un-hydrated in the system—see FIG. 25.

Adding zinc-doped clay particles to the geopolymer and blended matrix and increasing the alkali activator to alumino-silicate ratio enhanced the tensile strength properties of the mix (see FIG. 26). As discussed above, heavy meatal doped clay particles have the potential to get incorporated as a secondary source of alumino-silicate in the geopolymerization reaction. Increasing the alkali activator solution promoted the solubility and dissolution of clay particles and accelerated their geopolymerization reaction.

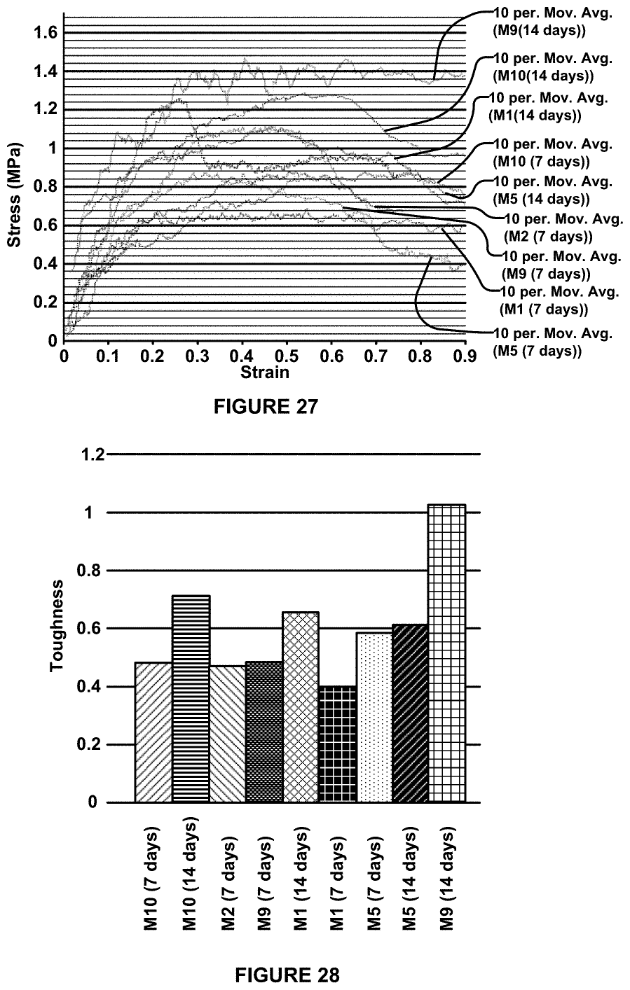

Ultimately, typical stress-strain curves were plotted for M1, M2, M5, M9 and M10 after 7 and 14 days in FIG. 27. Toughness values were calculated and are displayed in FIG. 28.

### 5.4 Bonding Test

The bond pull-off tests conducted by the inventors were used to evaluate the bond strength between an existing concrete surface and the ultimate coating material. The bond pull-off test conducted by the inventors determines the greatest perpendicular force (in tension) that a surface area can bear before a plug of material is detached. Failure typically occurs along the weakest plane within the system. This test was performed using the Delfesko Pull Off Adhesion Tester following the ASTM D4541, D7234.

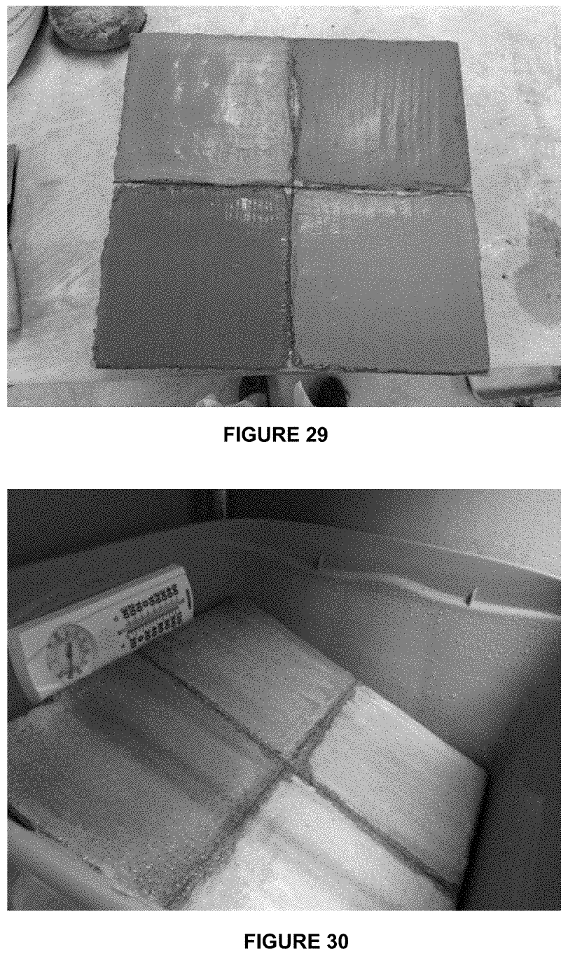

The mixes M2, M5, M9 and M10 (Table 7) were applied onto a well-scrubbed and SSD concrete blocks (FIG. 29). Then the samples were initially cured for 24 hours by plastic tenting to prevent moisture loss. After 24 hours, samples were placed in a closed container for a duration of 14 days (FIG. 30).

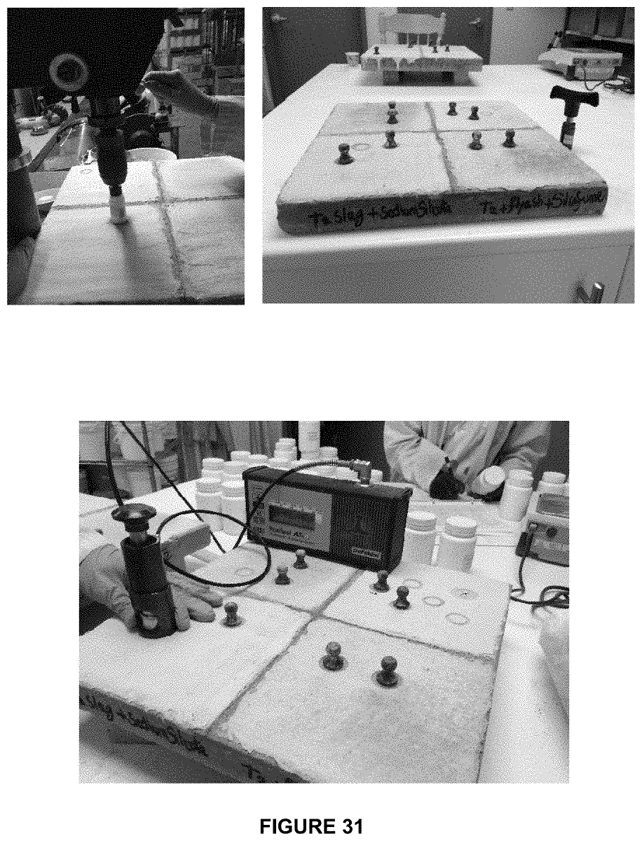

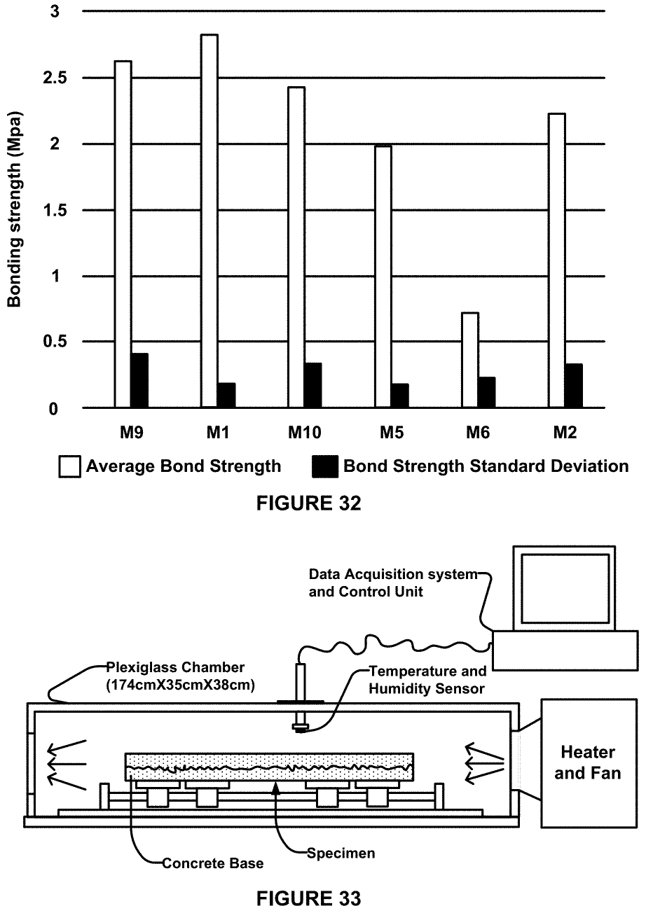

Once removed from the closed container, the coated concrete blocks were cored and a metal fixture was glued using rapid setting epoxy. Samples were then left at room temperature for 2 days to ensure maximum adhesion of the dollies to the surface. Measurements of bonding strength (pull-off) between the concrete and the coating material were determined at 17 days after the application by applying load at a steady rate to the disc by the test equipment until failure occurred in the specimen. Samples were tested following the ASTM D4541, D7234, as shown in FIG. 31. Three dollies were tested per sample.

The results were analyzed in terms of bonding strength and type of failure. When the bond tests were performed, the measured strength was controlled by the failure mechanism requiring the least stress. The average bonding strength for each sample is presented in Table 8.

The nominal tensile strength or adhesion, E, between the overlay material and concrete substrate is given by:

E=Fₚₑₐₖ/A (2)

in which Fₚₑₐₖ is the recorded failure tensile peak load (N) and A is the cross-sectional area of the test testing disc (mm²).

Notably, the mode and location of the failure were observed, since the failure can occur in the substrate, repair material or the bond or interface between the substrate and the repair material. The failure types including:
Bonding failure: when the entire coating detaches from the concrete base
Coating failure: when the weakest plane happens to be inside the coating, and the bonding between the coating and the base is unharmed
Partial Failure: when the failure mechanism consists of a mixture of bonding and coating failure.
Epoxy failure: when the detachment occurs between the test dolly and the coating surface, indicating the adhesive has failed.

TABLE 8
Average adhesion strength of coated samples

| | Average Bond | Bond Strength |
|---|---|---|
| Mix | Strength | Standard Deviation |
| M9 | 2.61 | 0.41 |
| M1 | 2.83 | 0.17 |
| M10 | 2.43 | 0.35 |
| M5 | 1.98 | 0.17 |
| M6 | 0.71 | 0.99 |
| M2 | 2.24 | 0.34 |

It may be noted that the results of the bonding test are dependent on the type of the equipment used, thickness of the repair material and the disc, geometry and dimension of the specimen, depth of cut drilling and loading rate. According to the literature, typical values of adhesion of repair materials or overlay to concrete substrate ranges from 0.41 to 3.44 MPa. EN1504-3 required bonding strength is at least 2 MPa.

According to the results, the average bond strength values (Table 8) of the materials evaluated by the inventors are higher than the tensile strength results (FIG. 7). This could be because of the shape, curing conditions (which affect the matrix) and demolding procedure of the samples used in the tensile strength test. In addition, tensile strength test samples could have been damaged slightly during demolding procedure. Specimens coated with zinc-doped multiphase composite materials exhibited comparable adhesion strength at early stages in comparison to the specimens coated with geopolymer.

### 5.5 Shrinkage

Shrinkage cracking at an early age has the potential to accelerate concrete deterioration and lead to leakage, reduced strength and failure. Surface cracks allow bacteria to penetrate the coating, causing rapid delamination and corrosion. The inventors conducted testing to study shrinkage induced cracking of developed materials. To determine the plastic shrinkage behavior of different materials, a simulation technique was implemented wherein fresh samples of the material were applied on a hardened concrete base and placed in a chamber, capable of simulating aggressive drying conditions that encourage shrinkage induced cracking.

The environmental chamber used for this experiment was a semi-enclosed rectangular box, 1705×1705×380mm, equipped with temperature and humidity probes, capable of regulating and monitoring the environment inside (FIG. 33). Three heating fans (240V, 4800 W with a 1/30 HP, 1550 RPM internal electrical fan) supplied heat to maintain a constant temperature of 50° C.±1° C., along with an approximate humidity of 5%. The heated air was allowed to escape through three 240×175mm openings, creating a rate of surface evaporation of approximately 0.8 kg/m²/h.

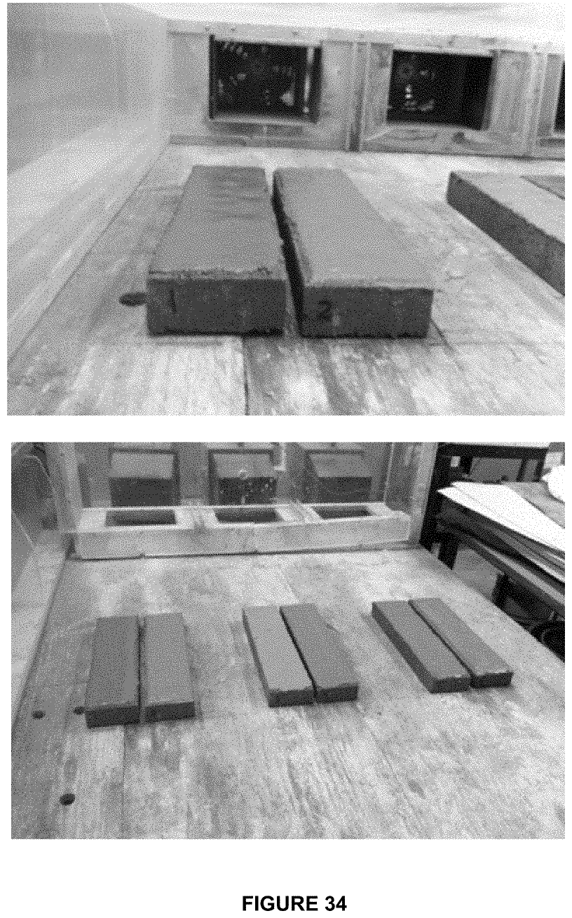

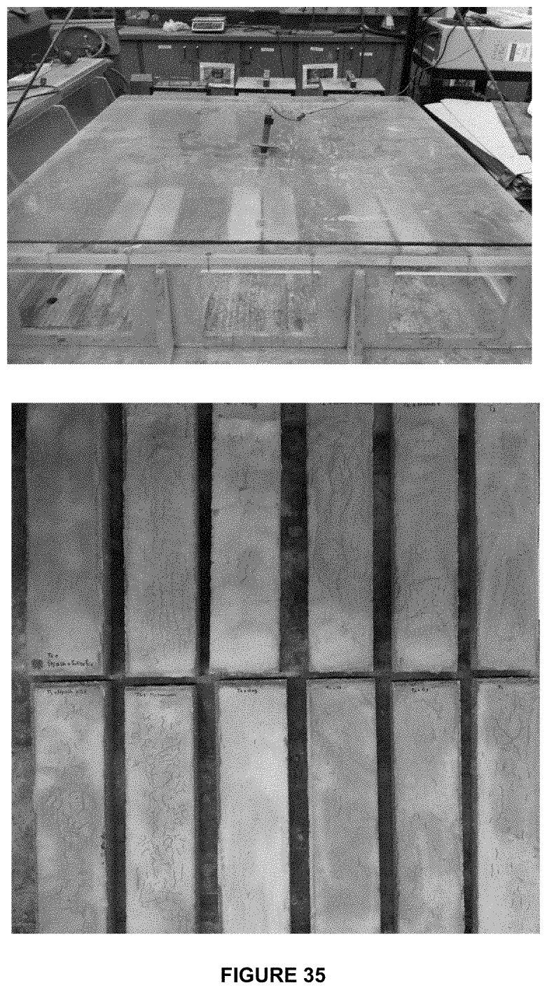

To create a suitable base for the coating materials, square concrete slabs with dimensions of 50×400×400mm were purchased and cut into 4 even pieces. Each smaller rectangular piece, 50×100×400mm, was then thoroughly cleaned with water and a steel wire brush, and kept in a saturated surface dry condition (SSD). Developed mixes M1, M2, M5, M6, M9 and M10 were brushed over each base and placed in the environmental chamber (FIG. 34). A set of six samples were placed in the simulation chamber at a time. Each set of samples was removed after 72 hours and the crack patterns were characterized (FIG. 35).

With two applicators applying the coating to the 6 samples, the first and last sample had a cast time difference of about 15 minutes. To minimize the potential error due to this cast time difference, each group of samples was tested twice, with different application orders. After the first 24 hours, very few cracks were visible on the samples, suggesting that the samples were still hydrating. Within 48 hours, a larger quantity of cracks was visible (FIG. 35). After 72 hours in the chamber, the samples seemed fully hydrated with visible cracks. A summary of results is presented in Table 9.

TABLE 9
Descriptive summary of plastic shrinkage test results
in experiments conducted by the inventors

| | Aug. 14, 72 hours | Aug. 17, 72 hours | Aug. 25, 72 hours | Sept. 1, 72 hours |
|---|---|---|---|---|
| M2 | Crack Distribution was | Moderate cracks | Almost no cracks | Moderate cracks |
| | small, similar to | comparable to set 1 | observed | comparable to set 1 |
| | geopolymer | (almost same results) | | and 2 |
| | • | | | Consistent |
| | Partial delamination | | | workability |
| | noticed | | | |
| M6 | Longer vertical cracks | Long cracks, poor | • | — |
| | compare to | performance | | |
| | geopolymer sample | Same results as set 1 | | |
| | Few deep cracks | Very poor performance | | |
| | compared to M1 | | | |
| M9 | Small micro cracks | • | Small cracks, | • |
| | | | performance similar | |
| | | | to set 1 | |
| M10 | Long vertical cracks | Cracks were 20% less | Same results | • |
| | • | than set 1, needed to | compare to set 2 | |
| | | test another batch to | and overall less | |
| | | verify the results | cracks compare to | |
| | | Better performance | M2 | |
| | | compare to M6 | | |
| M5 | • Smaller cracks | • | • | Results very similar |
| | compare to | | | to set 1 |
| | M9 | | | More cracks |
| | | | | observed compare |
| | | | | to geopolymer |
| M1 | Less crack compare to | Crack were | • | Almost no cracks |
| | other samples | comparable to set 1 | | observed |

### 5.6 Surface Morphology

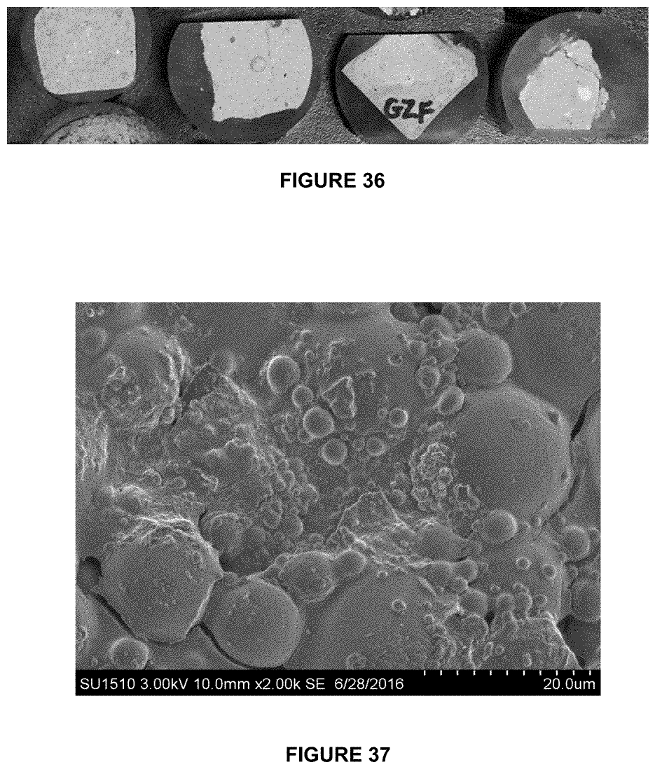

SEM-EDS was used to investigate the microstructure and composition of different mixes including geopolymer, blended matrix and zinc-doped mixes. Samples were cast, cured and impregnated using epoxy-based resin. Then epoxy impregnated samples were cut with saw and polished with diamond grit. Ultimately samples were cleaned in desktop UV cleaner chamber and dried at 50° C. (FIG. 36).

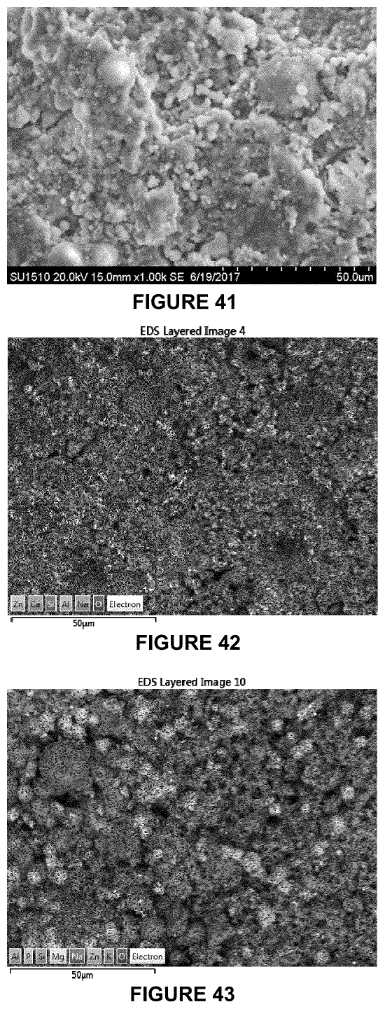

FIGS. 37-41 are SEM images of mixes, M2 (blended mix of geopolymer and magnesium phosphate), M5 (M1 integrated with zinc oxide particles), M6 (blended mix integrated with zinc oxide particles), M9 (M1 integrated with Zn-doped clay particles) and M10 (blended mix integrated with Zn-doped clay particles).

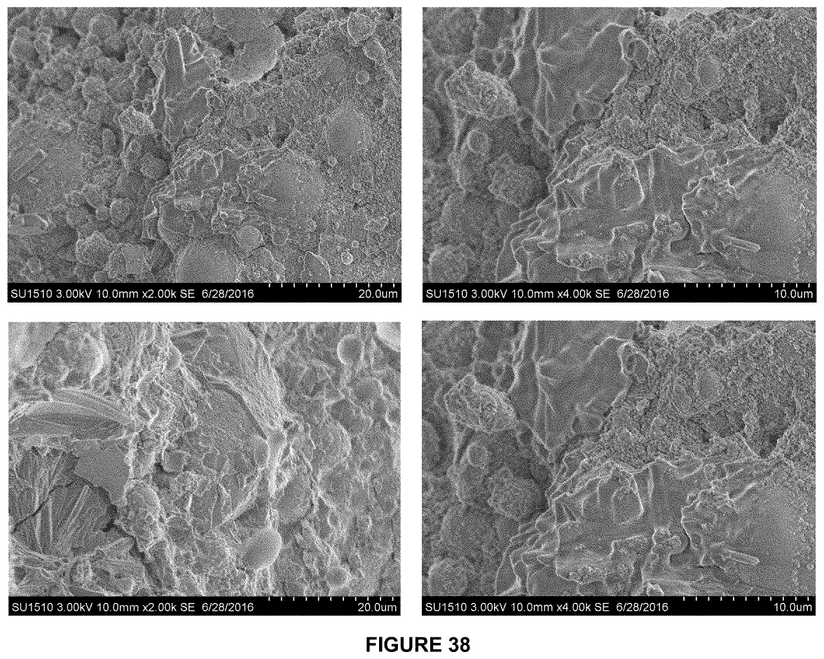

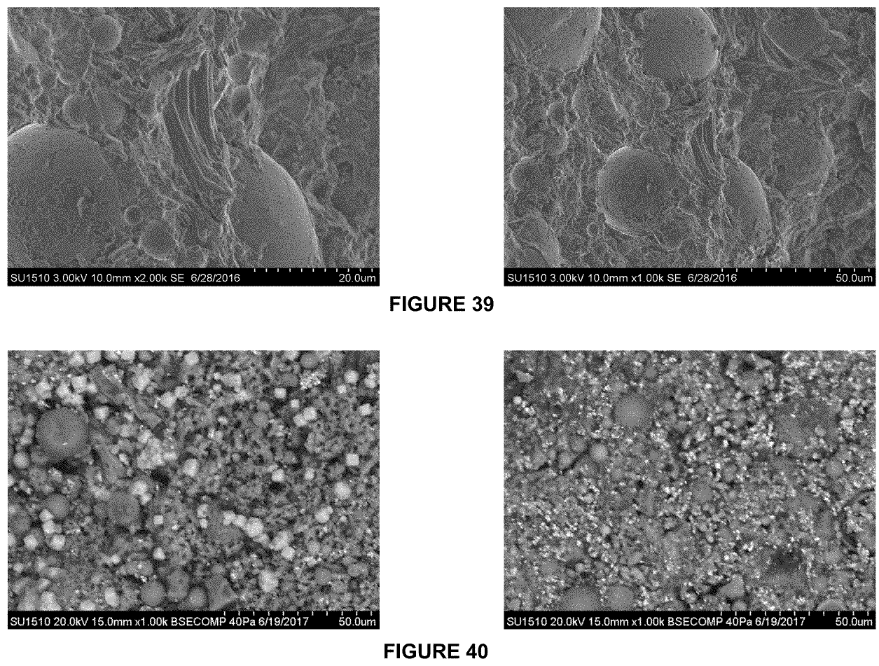

As seen in FIG. 37, this geopolymer sample (M1) comprised an amorphous phase which could be responsible for its high strength and dense structure. Mixes including magnesium phosphate compound generally tended to yield crystalline structures (FIG. 38 (M2)). However, when a source of amorphous silica, such as fly ash, was added to the crystalline structure, amorphous or glassy (structures with short range disordered) phases were formed within them (see FIG. 39). Fly ash provides amorphous silica to the reaction which converts it into a dense geopolymer. So the network of crystalline magnesium phosphate minerals are connected by silicate geopolymeric amorphous materials.

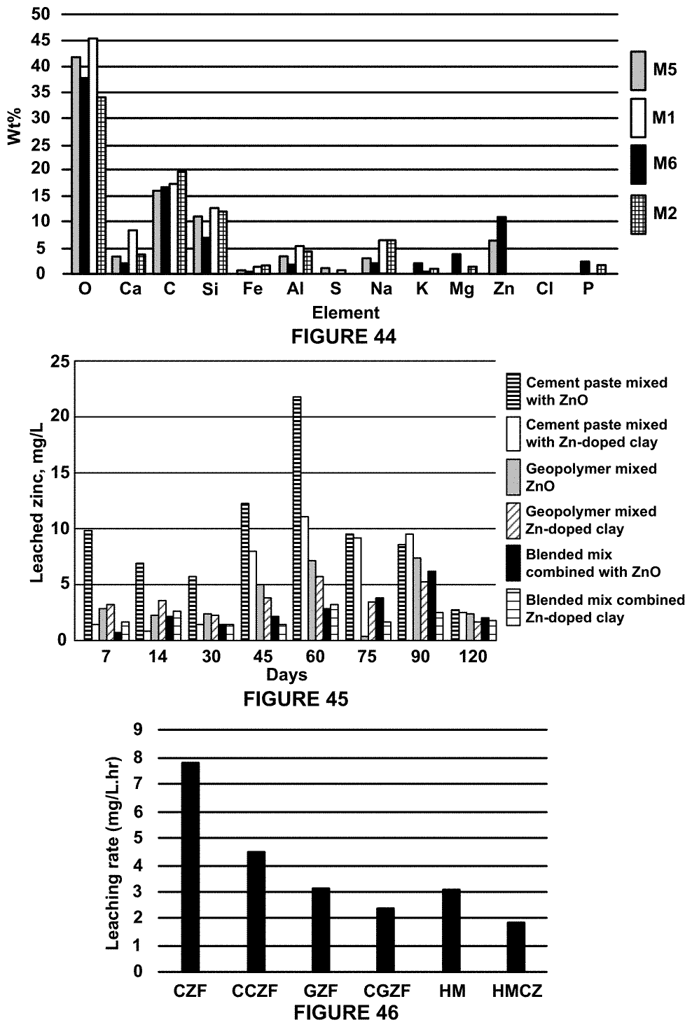

SEM-EDS analysis of the samples is shown in FIG. 42. As described before, geopolymers are formed by polymerization of inorganic molecules containing mainly aluminium, silicon, oxygen and other elements. As may be seen in FIG. 42, geopolymer matrix (M5) encapsulated zinc particles physically (charge balancing of Al in framework) within the three-dimensional alumino-silicate network. According to FIG. 44, Na and Ca amounts are reduced in M5 and M6 compare to M1 and M2 and may indicate that Zn particles were replaced by Na, Ca ions in the system.

Zn particles are also encapsulated in the 3D framework of the blended mix (FIG. 43). Comparing chemical composition of M6 with M2 suggests that Zn is replaced by Al, Na or Ca. The amount of the Zn particles encapsulated in the blended mix is higher than the geopolymer, which indicates encapsulation degree in the blended mix increased compared to geopolymer mix (FIG. 44).

### 5.7 Leaching and Chemical Stability

To evaluate the stability of the antibacterial composites, leaching tests were conducted on the samples. Atomic absorption spectrometry was used to measure leaching of zinc ions. The leaching test was carried out on immersed cylindrical samples (D=20 mm, h=30 mm) in 20 ml of the leaching solution containing biogenic acid and distilled water (pH=1.5) at 30° C. for 120 days. The suspensions were continuously stirred during this period and samples were collected every 7 days. Each time the leachate samples were centrifuged, filtered and analyzed using atomic absorption spectrometer.

The leaching rate is measure by dividing the measured mass of Zn according to the time of exposure in which Vd is the leaching rate per unit area (pg/(hr·cm²), Xd is the maximum amount of Zn leached out of the sample during the experiment in micrograms, T is the period of the test (hr) and S is the area of exposure (cm²).

$$Vd = \frac{Xd}{TS} \qquad ( 3 )$$

Leaching of zinc was used as an expression of the efficiency of encapsulation of Zn ions in different mixes. Our findings (shown in FIG. 45) demonstrate that the multiphase composite coating is more chemically stable in aggressive (low pH) environments compared to other coatings. The percentage of leaching is significant in the first leaching and decreased as leaching is repeated.

According to FIG. 45, the amount of leached Zn from cement mortar samples reduced when Zn was encapsulated in clay particles. However, slight differences were observed for geopolymer samples and composite coating mixed with zinc oxide and Zn-doped clay. This shows that geopolymer and composite coating matrixes were able of encapsulating Zn particles in their network. The relatively high amount zinc leached out of cement paste mixed with ZnO is due to large surface cracks that occur on the surface of the samples.

The leached concentration of Zn after 120 days is less than 3 mg/L for geopolymer and blended (geopolymer and magnesium cement) samples. Leaching rate for geopolymer and blended samples combined with Zn-doped clay particles was around 2.5 and 2 mg/(L·hr) which was the minimum compared to the other tested materials (FIG. 46). This could be explained by the entrapment and attachment of Zn particles to the bentonite clay matrix. Also, the swelling properties of clay minerals has the blocking effect against the dissolved ions in the water inside the pores. Zn-doped clay particles also successfully reduced the leaching rate in Portland cement mortar samples. The leaching rate of cement mortar samples mixed with ZnO was reduced by almost 50% compare to samples with Zn-doped clay.

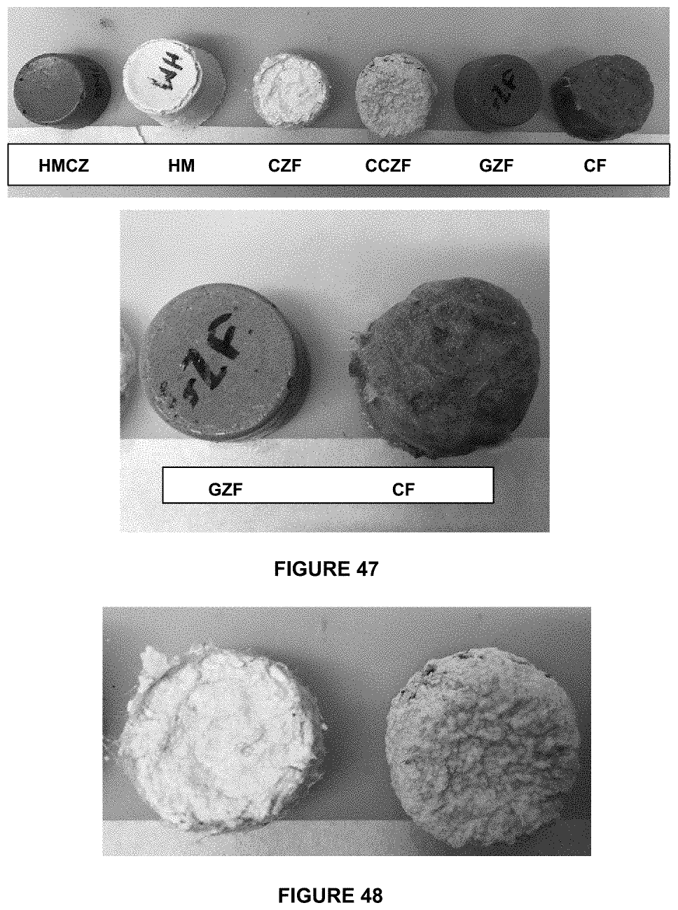

In addition, to acid leaching, according to FIGS. 47 and 48, CZF (the cement mortar sample mixed with ZnO) and CF (the cement mortar sample without zinc) had deformed and degraded completely in acid solution compared to other mixes. This may be explained by their higher calcium content compared to the other evaluated specimens. CCZF (cement paste combined with Zn-doped clay particles) also exhibited severe erosion and significant dimensional change. Leaching is clear on the surface of the samples after 6 weeks. However the amount of leached Zn in CCZF is 50% less than CZF.

FIG. 47 shows the visual appearance of GZF (the geopolymer sample mixed with ZnO) and HMCZ (the blended sample of geopolymer and magnesium phosphate mixed with Zn-doped clay particles) and HMZ (the blended geopolymer and magnesium phosphate mixed with ZnO) specimens following 16 weeks immersion in acid is. GZF shows very small alteration in the visual appearance, color change and erosion. Based on visual evaluation, it could be concluded that geopolymer and composite coatings appear to be durable solutions in acidic environments.

### 6. Discussion on the Development of Composite Coating Integrated With Zn

Prevention or mitigation of concrete bio-corrosion typically involves modification of the concrete mix, introduction of novel cementitious material or application of a chemical/antimicrobial resistant thin coating layer on the surface of an existing concrete structure (e.g. on the inner surface of a sewage pipe). The techniques can inhibit biological activity or provide protective layer between concrete surface and corrosive materials which may come into contact with the structure. Major materials used to coat concrete pipes in the past include cement mortar, epoxy mortar and polymer-based coatings with variable degrees of success. Most of the coating materials are not resistant to acid attack, have bonding issues with the concrete substrate and, in many cases, that bacteria is capable of penetrating the coating material, growing on the concrete surface beneath the coating and destroy the bond between the structure and the coating material. So, historical success with different types of linings and coating materials has been variable.

As discussed herein, higher strength and/or lower porosity do not necessarily enhance the resistance of material to acid attack. However, the chemical nature of the material is a factor that is indicative of the resistance of the coating material in acidic and corrosive environments. Cement-based materials have limited ability to resist acid attack over time in aggressive environments, due to their chemical composition and calcium content. The hydrate phases, calcium hydroxide and calcium silicate hydrate, and their corresponding amounts in the medium (which are in turn dependent on the proportion contributed by the binder) are significant determinants of how stable chemically the matrix becomes. Water, which plays a key role in the cementitious process, also actively participates in the chemical reaction. So, examining materials that produce non-traditional hydration products to improve the resistance of concrete pipes and other structures to acid attack has recently risen in interest.

Further, concrete production requires significant quantities of Portland cement, production of which is a major contributor to greenhouse gas emissions and raw material. Production of one tone of Portland cement requires about 2.8 tons of raw materials and is responsible for about 1 ton of greenhouse gas (CO₂) emission. So, there is a need for replacing cement-based repair materials with durable, economic, effective and also sustainable and environmental friendly alternatives.

In the context of pipe rehabilitation, protective antibacterial coatings are the most widely used means of preventing further corrosion. However there are common issues associated with these types of coatings such as: cost; tendency for the propagation of cracks, pinholes or rips; delamination; corrosion; compatibility with the host material; short bio-resistance lifetime; poor adhesion to the substrate material; long setting time; considerable thermal expansion and toxicity.

Challenges of using antibacterial agents, bioactive chemicals (biocides) or heavy metals in coating materials include short bio-resistance life time and efficiency. Leachability into the environment, safety concerns and regulations restrict levels of certain metals in sewer systems. Other challenges of using these antibacterial agents include poor adhesion to concrete substrates and cost. Also in high dosages such antibacterial agents might affect the structural properties of the coating material. Still further, some of these antibacterial agents are toxic and undesirable leaching of toxic antibacterial agents into the surrounding environment may cause problems, such as pollution of water and soil. Also, overuse and abandoned leaching of antibacterial agents could lead to the rapid development of bacteria that are immune to multiple drugs. Pollution of water and soil with toxic heavy metals and bioactive chemicals is of major concern for human health and environment.

Aspects of the invention provide structural coating compositions comprising antibacterial agents which are immobilized inside the coating. Two types of corrosion resistant coating materials were evaluated in the experiments conducted by the inventors. The first material comprised a geopolymer matrix and the second comprising a blended mix of geopolymer and magnesium phosphate hydrates (also referred to herein as magnesium cement and/or magnesium phosphate).

The inventors have identified a particular non-limiting embodiments which may be used to implement a coating or multi-phase composite material comprising:
a geopolymer (55-70 wt %) which may itself comprise: an alumino-silicate source 35-30 wt % (e.g. any of the types of alumino-silicate sources described herein or other alumino-silicate sources having the properties described herein); and an alkaline activator solution 30-40 wt % (which may comprise, for example, a combination of sodium silicate and sodium hydroxide or a combination of potassium silicate and potassium hydroxide);
magnesium cement* (23-37 wt %) which may itself comprise: water (9-15 wt %); magnesium oxide or magnesium silicate (8-12 wt %); and mono-potassium phosphate or ammonium dihydrogen phosphate or sodium dihydrogen phosphate (6-11 wt %);
an antibacterial carrier doped with an antibacterial agent (10-15 wt %). The antibacterial carrier may include clays, sodium bentonite or other types of bentonite clay, zeolite, halloysite clay, metakaoline, other types of carrier materials comprising silica particles and/or amorphous alumina). The antibacterial agent which is doped into the carrier may comprise heavy metals, such as Ti, Zn, Cu, Au, Ni, W, molecules comprising such heavy metals, or more complex biocides);
fiber* (1-1.5 wt %) (e.g. ply-vinyl alcohol fiber or other type of structural fiber to provide tensile strength); and
sodium tetraborate* (also known as sodium borate or borax) (0.1-0.2%) wich may be used to slow down the curing of the magnesium cement. * indicates optional in some implementations.

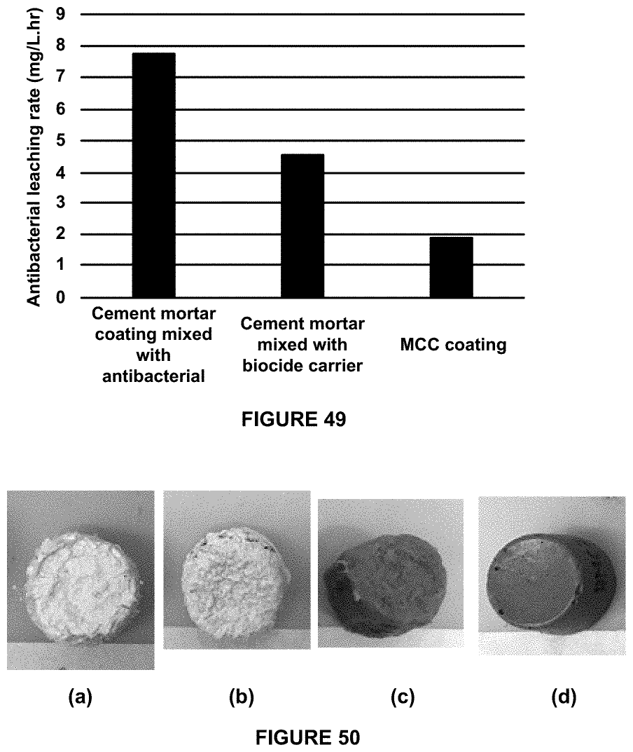

Compositions fabricated in accordance with these embodiments (which may be referred to as multiphase composite coating or MCC embodiments) exhibit a number of advantageous properties when compared with cement or mortar coatings. One such advantageous property is the rate of leaching of antibacterial agents. FIG. 49 shows plots of experimental antibacterial leaching rates which demonstrate this property. The leftmost bar in the FIG. 49 plot represents the relatively high antibacterial leaching rate of prior art cement mortar mixed with a ZnO antibacterial agent, the middle bar represents the intermediate antibacterial leaching rate when a cement mortar is mixed with a Zn-doped carrier (e.g. Zn-doped clay) and the rightmost bar represents the low antibacterial leaching rate when the Zn-doped carrier is mixed with the MCC coating of the above embodiments.

FIG. 50 shows another advantageous property of the MCC embodiments having regard to chemical stability after immersion in an acidic environment for 16 weeks. More specifically, FIG. 50 shows: (a) a cement mortar sample mixed with ZnO antibacterial agent in acidic environment after 16 weeks of immersion; (b) a cement mortar sample mixed with a Zn-doped carrier (e.g. Zn-doped clay) in acidic environment after 16 weeks of immersion; (c) a cement mortar sample (without antibacterial agent) in acidic environment after 16 weeks of immersion; (d) a MCC embodiment sample in acidic environment after 16 weeks of immersion. FIG. 50 clearly shows that the MCC sample (d) exhibits greater chemical stability in the acidic environment of the experiment.

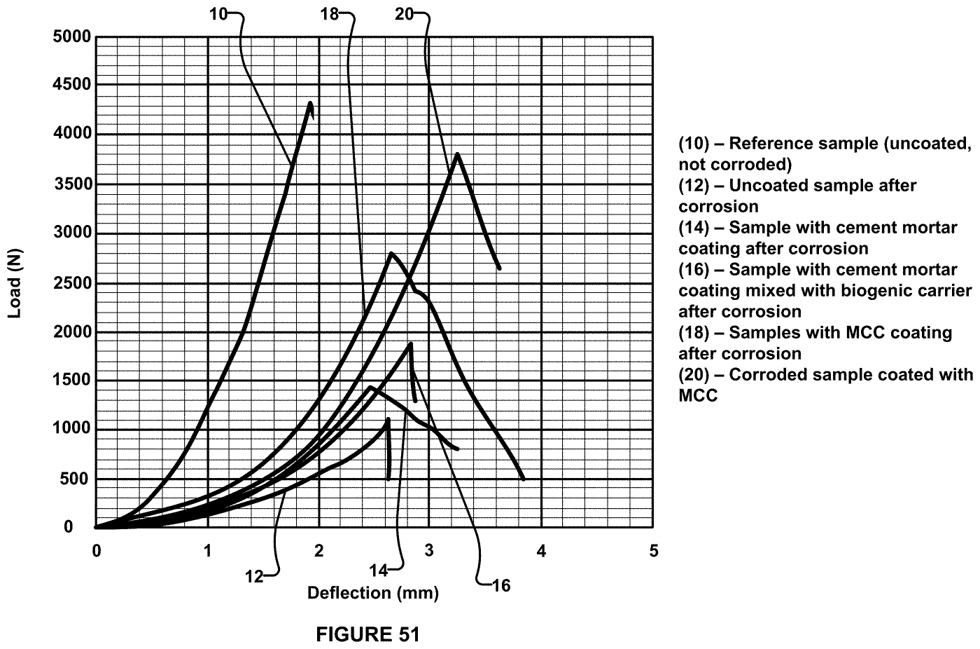

FIG. 51 shows another advantageous property of the MCC embodiments having regard to strength loss (reduction in load bearing capacity) of concrete samples after being in a bio-corrosion testing chamber over a six month period. In FIG. 51, plot 10 (with the highest load-bearing capacity) represents a concrete sample that was not subjected to the bio-corrosion testing chamber. Then, in FIG. 51 (of the samples subjected to the bio-corrosion testing chamber): plot 12 (with the lowest load-bearing capacity) represents an uncoated concrete sample; plot 14 (with the second lowest load-bearing capacity) represents a sample of concrete coated with cement mortar; plot 16 (with the mid-range load bearing capacity) represents a concrete sample coated with cement mortar and mixed with antibacterial agent in a carrier; plot 18 (with MCC coating after corrosion) represents a concrete sample of concrete coated with the MCC coating; and plot 20 (corroded sample coated with MCC) represents a concrete sample that, after being subjected to the bio-corrosion testing chamber, was coated with the MCC coating. As can be seen by comparing plot 18 to plots 12, 14 and 16, a concrete sample coated with the MCC coating has a smaller reduction in load bearing capacity after being in a bio-corrosion testing chamber over six-month period as compared to an uncoated sample, a sample with a cement mortar coating and a sample mixed with a biogenic carrier. Similarly, as can be seen by comparing plots 12 and 20, coating a concrete sample with the MCC coating after being in a bio-corrosion testing chamber over six-month period significantly increases the load bearing capacity of the concrete sample.

While a number of exemplary aspects and embodiments have been discussed above, those of skill in the art will recognize certain modifications, permutations, additions and sub-combinations thereof. By way of non-limiting example:
Aspects of the invention relate to geopolymerizing structural material compositions that are resistant to degradation due to bio-corrosion. Such structural material compositions are often described herein as “coatings” or the like, because they can be used to coat existing structures to protect the existing structures from bio-corrosion. However, such structural material compositions can additionally or alternatively be mixed with concrete and/or other construction materials (e.g. mixed with curable construction materials prior to curing) and the mixture can then be used to fabricate structures. Also, such structural material compositions can additionally or alternatively be used on their own or together with other construction materials to fabricate structures.

It is therefore intended that the following appended claims and claims hereafter introduced are interpreted to include all such modifications, permutations, additions and sub-combinations as are consistent with the broadest interpretation of the specification as a whole.

1.-58. (canceled)

59. A structural material composition comprising:
a geopolymer matrix, the geopolymer matrix formed from an alumina silicate source and an alkaline activator; and
an antibacterial agent (e.g. biocide and/or heavy-metal based antibacterial agent) encapsulated in an antibacterial agent carrier to form a first plurality of encapsulated antibacterial agent particles;
wherein the first plurality of encapsulated antibacterial agent particles is integrated with the geopolymer matrix during polymerization.

60. A structural material composition according to claim 59 wherein the geopolymer matrix defines a plurality of first voids during polymerization and wherein at least a portion of one or more of the plurality of encapsulated antibacterial agent particles are located in the plurality of first voids after polymerization or are co-geopolymerized with the geopolymer matrix.

61. A structural material composition according to claim 59 wherein chemical bonds are formed between the encapsulated antibacterial agent particles and the geopolymer matrix during polymerization.

62. A structural material composition according to claim 59 wherein the antibacterial agent is encapsulated in the antibacterial agent carrier through an ion exchange process to form the first plurality of encapsulated antibacterial agent particles.

63. A structural material composition according to claim 59 wherein encapsulating the antibacterial agent in the antibacterial agent carrier comprises locating the antibacterial agent in one or more pores of the antibacterial agent carrier.

64. A structural material composition according to claim 59 wherein the alumina silicate source comprises fly ash, slag or metakaoline, wherein the alumina silicate contains less than 15 wt % CaO, wherein the alumina silicate source exhibits loss-on ignition (LOI) less than 5 wt %, wherein the alumina silicate source contains less than 10 wt % Fe₂O₃, and wherein the alumina silicate source contains silica content of 40% to 50 wt %.

65. A structural material composition according to claim 59 wherein the antibacterial agent comprises a heavy metal capable of undergoing ion exchange with the antibacterial agent carrier.

66. A structural material composition according to claim 59 wherein the antibacterial agent comprises a compound comprising one or more of: Zn, Ti, W, Cu, Ag, Ni and sodium tungstate (Na₂WO) or an oxide of one or more of: Zn, Ti, W, Cu, Ag, and Ni.

67. A structural material composition according to claim 59 wherein the antibacterial agent carrier comprises at least one of zeolite, halloysite clay, metakaoline and sodium bentonite clay (Al₂H₂Na₂O₁₃Si₄).

68. A structural material composition according to claim 59 wherein the alkaline activator solution comprises at least one of a sodium hydroxide (NAOH) solution, a sodium silicate (Na₂SiO₃) solution, potassium hydroxide (KOH) solution and potassium silicate (K₂SiO₃) solution.

69. A structural material composition according to claim 68 wherein the concentration of the alkaline activator solution is in a range of 10-14 Molar.

70. A structural material composition according to claim 59 further comprising magnesium cement.

71. A structural material composition according to claim 70 wherein the magnesium cement is formed from one or more of: magnesium oxide (MgO), magnesium silicate (MgSiO₃), mono-potassium phosphate, ammonium dihydrogen phosphate and sodium dihydrogen phosphate.

72. A structural material composition according to claim 70 further comprising one or more of: sodium borate, sodium tetraborate and disodium tetraborate.

73. A structural material composition according to claim 70 wherein the magnesium cement, when cured, defines a plurality of second voids and wherein at least a portion of one or more of the plurality of encapsulated antibacterial agent particles are located in the plurality of second voids after curing.

74. A structural material composition according to claim 70 wherein the magnesium cement is located in one or more of the plurality of first voids after polymerization.

75. A structural material composition according to claim 70 wherein the magnesium cement, when cured, defines a secondary matrix combined with the geopolymer matrix and additional bonding sites for receiving encapsulated antibacterial agent particles.

76. A structural material composition according to claim 59 further comprising reinforcing fibers.

77. A structural material composition according to claim 76 wherein the reinforcing fibers comprise at least one of polymer fibers, poly-vinyl alcohol fibers, glass fibers and carbon fibers.

78. A structure comprising:
a body, the body comprising a structural material composition according to claim 59.

79. A structure according to claim 78 wherein the body comprises a pipe.

80. A structure according to claim 78 wherein body pipe comprises any type of infrastructure or structure exposed to deterioration, aggressive environment, bacteria conducive environments (e.g. high humidity, long cycles of humidification and drying, high carbon dioxide concentrations, high concentrations of chloride ions or other salts or high concentrations of sulfates and acidic environments), molds, fungus and microbiological corrosion and any type of deterioration arising from biological sources, such as wastewater pipes, oil and gas pipes, residual water treatment plants, marine infrastructure and storing tanks.

81. A structure comprising:
a body,
a coating covering at least a portion of a surface of the body, the coating comprising a structural material composition according to claim 59.

82. A structure according to claim 81 wherein the body comprises a pipe.

83. A structure according to claim 81 wherein the body comprises any type of infrastructure or structure exposed to deterioration, aggressive environment, bacteria conducive environments (e.g. high humidity, long cycles of humidification and drying, high carbon dioxide concentrations, high concentrations of chloride ions or other salts or high concentrations of sulfates and acidic environments), molds, fungus and microbiological corrosion and any type of deterioration arising from biological sources, such as wastewater pipes, oil and gas pipes, residual water treatment plants, marine infrastructure and storing tanks.

84. A structure according to claim 81 wherein the body comprises a polymer or a metal.

85. A coating for reducing bio-corrosion of a structure that is at least partially covered in the coating, the coating comprising:
a structural material composition according to claim 59.

86. A method for applying a coating to at least a portion of a structure for reducing bio-corrosion of the at least a portion of the structure, the method comprising:
providing a structural material composition according to claim 59;
spraying the structural material composition onto the structure to cover the at least a portion of the structure.

87. A method according to claim 86 wherein spraying the structural material composition onto the structure comprises pneumatically projecting the structural material composition onto the structure to cover the at least a portion of the structure.

88. A method for applying a coating to at least a portion of a structure for reducing bio-corrosion of the at least a portion of the structure, the method comprising:
providing a structural material composition according to claim 59;
brushing the structural material composition onto the structure to cover the at least a portion of the structure.

89. A method of forming a structure having improved resistance to bio-corrosion, the method comprising:
mixing a first material with a structural material composition according to claim 59 to form a curable material;
pouring the curable material into a formwork;
curing the curable material in the formwork to form the structure.

90. A method of forming a structure having improved resistance to bio-corrosion, the method comprising:
pouring, into a formwork, a structural material composition according to claim 59;
curing the structural material composition in the formwork to form the structure.

91. A coating for reducing bio-corrosion of at least a portion of a structure, the coating comprising:
a structural material composition according to claim 59.
